(19) United States
(12) Patent Application Publication
(10) Pub. No.: US 2021/0390503 A1
(43) Pub. Date: Dec. 16, 2021

(54) COURIER, PRIVATE PARTY SHIPPER, E-COMMERCE AND RETAILER INTEGRATION WITH BIG DATA ANALYTICS

(71) Applicant: Luvin Ariza, Fort Lauderdale, FL (US)

(72) Inventor: Luvin Ariza, Fort Lauderdale, FL (US)

(21) Appl. No.: 17/296,125

(22) PCT Filed: Apr. 6, 2020
(86) PCT No.: PCT/US2020/026856

§ 371 Date: May 21, 2021

Related U.S. Application Data
(60) Provisional application No. 62/829,227, filed on Apr. 4, 2019.

(51) Int. Cl. G06Q 10/08

(52) U.S. Cl. CPC G06Q 10/0833; G06Q 10/0834

(57) ABSTRACT

A platform that provides easy shipment of orders across multiple retailers, online e-commerce platforms or otherwise, and allows shipper to properly bill the recipient for shipment may be provided. Each user chooses a unique identifier (ID). Each ID may be associated with plurality of PINs, wherein each PIN may represent a physical address. Having used the ID and PINs across multiple retailers for order fulfillment/shipment, the platform may provide tracking of all orders across multiple retailers and couriers. The user may be able to reroute or return of packages. At a destination, a plurality of smart devices may be used to verify the shipment including, but not limited to, a sensor mounted inside a mailbox notifying when new mail is received, a door mat with an integrated scale, and a camera which may identify package characteristics and activity and notify user. Each smart device may be integrated with the platform.

### RELATED APPLICATION

The present application is a U.S. National Stage under 35 U.S.C. § 371 of International Application No. PCT/US20/26856, filed on Apr. 6, 2020, which claims benefit under the provisions of 35 U.S.C. § 119(e) of U.S. Provisional Application No. 62/829,227, filed on Apr. 4, 2019, the entire contents of which are incorporated in this application by reference.

It is intended that each of the referenced applications may be applicable to the concepts and embodiments disclosed herein, even if such concepts and embodiments are disclosed in the referenced applications with different limitations and configurations and described using different examples and terminology.

### BACKGROUND

In some situations, a user has ordered multiple packages from multiple e-commerce stores and the user may frequently change their ship-to address. Furthermore, the user that wished to receive the purchased goods, has to enter his destination address with every purchase. The management of all these variables and entry of shipping information across multiple platforms may become a very complicated and time-consuming process. Imagine a single platform that consolidates all these variables and offers single identifier entry, shipment tracking across multiple couriers, easy rerouting of a shipment, confirmation, remote acceptance of delivery and simplified return of the shipment. Additionally, in some situations, a user has no choice in what courier they pick when ordering online. For example, when ordering from e-bay, the seller sets the courier, speed, and price of shipping. Thus, the conventional strategy is to accept the courier choice, speed, and price of the retailer, and to re-enter all required shipping information with every purchase. This often causes problems because the conventional strategy does not allow for a competitive marketplace among couriers. For example, while shopping on Overstock, the user may not choose the carrier, such as UPS, Fed-Ex, DHL or other non-standard delivery services and their corresponding rates and shipping speeds.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

In one aspect, the present disclosure relates to a system configured for managing a shipment, the system comprising: one or more hardware processors configured by machine-readable instructions to: receive a designation of at least one parcel to be shipped; identify a shipping user of a plurality of users associated with the at least one parcel to be shipped, the shipping user being sub-defined as at least one of the following: a retailer comprising of at least one of the following: an online retailer, and a brick and mortar store, and a desiring user that wishes to ship the at least one parcel; retrieve a unique identifier associated with the shipping user, the unique identifier associated with the shipping user corresponding to a plurality of shipping pins; determine a pick-up address and location for the at least one parcel based on a shipping pin of the plurality of shipping pins associated with the shipping user; retrieve a unique identifier associated with the receiving user, the unique identifier associated with the receiving user corresponding to a plurality of receiving pins; determine a drop-off address and location for the at least one parcel based on a receiving pin of the plurality of receiving pins associated with the receiving user; designate a courier for a delivery of the at least one parcel, wherein designating the courier comprises selecting from a plurality of couriers for the delivery of the at least one parcel; provide the courier with instructions; and manage a shipment of the at least one parcel; wherein managing the shipment of the at least one parcel comprises establishing a pick-up point based on the shipping pin associated with the shipping user; wherein managing the shipment of the at least one parcel comprises establishing a drop-off point based on the receiving pin associated with the receiving user; wherein managing the shipment of the at least one parcel comprises enabling a change of the shipping pin selection associated with the shipping user and updating the pick-up point based on the change of the shipping pin associated with the shipping user; wherein managing the shipment of the at least one parcel comprises enabling a change of the receiving pin selection associated with the receiving user and updating the drop-off point based on the change of the receiving pin associated with the receiving user; and wherein managing the shipment of the at least one parcel comprises updating the courier with updated instructions corresponding to the shipment.

In another aspect, the present disclosure relates to a method for managing a shipment, comprising: receiving a designation of at least one parcel to be shipped; identifying a shipping user of a plurality of users associated with the at least one parcel to be shipped, the shipping user being sub-defined as at least one of the following a retailer comprising of at least one of the following an online retailer and a brick and mortar store and a desiring user that wishes to ship the at least one parcel; retrieving a unique identifier associated with the shipping user, the unique identifier associated with the shipping user corresponding to a plurality of shipping pins; determining a pick-up address and location for the at least one parcel based on a shipping pin of the plurality of shipping pins associated with the shipping user; retrieving a unique identifier associated with the receiving user, the unique identifier associated with the receiving user corresponding to a plurality of receiving pins; determining a drop-off address and location for the at least one parcel based on a receiving pin of the plurality of receiving pins associated with the receiving user; and designating a courier for a delivery of the at least one parcel, wherein designating the courier comprises selecting from a plurality of couriers for the delivery of the at least one parcel; providing the courier with instructions, and managing a shipment of the at least one parcel, wherein managing the shipment of the at least one parcel comprises establishing a pick-up point based on the shipping pin associated with the shipping user, wherein managing the shipment of the at least one parcel comprises establishing a drop-off point based on the receiving pin associated with the receiving user, wherein managing the shipment of the at least one parcel comprises enabling a change of the shipping pin selection associated with the shipping user and updating the pick-up point based on the change of the shipping pin associated with the shipping user, wherein managing the shipment of the at least one parcel comprises enabling a change of the receiving pin selection associated with the receiving user and updating the drop-off point based on the change of the receiving pin associated with the receiving user, wherein managing the shipment of the at least one parcel comprises updating the courier with updated instructions corresponding to the shipment.

In another aspect, the present disclosure relates to a non-transient computer-readable storage medium having instructions embodied thereon, the instructions being executable by one or more processors to perform a method for managing a shipment, the method comprising: receiving a designation of at least one parcel to be shipped; identifying a shipping user of a plurality of users associated with the at least one parcel to be shipped, the shipping user being sub-defined as at least one of the following a retailer comprising of at least one of the following an online retailer and a brick and mortar store and a desiring user that wishes to ship the at least one parcel; retrieving a unique identifier associated with the shipping user, the unique identifier associated with the shipping user corresponding to a plurality of shipping pins; determining a pick-up address and location for the at least one parcel based on a shipping pin of the plurality of shipping pins associated with the shipping user; retrieving a unique identifier associated with the receiving user, the unique identifier associated with the receiving user corresponding to a plurality of receiving pins; determining a drop-off address and location for the at least one parcel based on a receiving pin of the plurality of receiving pins associated with the receiving user; designating a courier for a delivery of the at least one parcel, wherein designating the courier comprises selecting from a plurality of couriers for the delivery of the at least one parcel; providing the courier with instructions; managing a shipment of the at least one parcel; wherein managing the shipment of the at least one parcel comprises establishing a pick-up point based on the shipping pin associated with the shipping user; wherein managing the shipment of the at least one parcel comprises establishing a drop-off point based on the receiving pin associated with the receiving user; wherein managing the shipment of the at least one parcel comprises enabling a change of the shipping pin selection associated with the shipping user and updating the pick-up point based on the change of the shipping pin associated with the shipping user; wherein managing the shipment of the at least one parcel comprises enabling a change of the receiving pin selection associated with the receiving user and updating the drop-off point based on the change of the receiving pin associated with the receiving user; and wherein managing the shipment of the at least one parcel comprises updating the courier with updated instructions corresponding to the shipment.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a system configured for managing shipments, in accordance with the present disclosure.

FIG. 2 illustrates a method for managing shipments, in accordance with the present disclosure.

FIG. 3 is a block diagram of a system including a computing device for performing the method of FIG. 2.

FIG. 4 illustrates a system configured for managing shipments, in accordance with the present disclosure.

FIG. 5 illustrates a method for user creation, in accordance with the present disclosure.

FIG. 6 illustrates a method for managing shipments, in accordance with the present disclosure.

FIG. 7 illustrates a method for returning shipments, in accordance with the present disclosure.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of Major Courier and e-Commerce Integration with Big Data Analytics, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

A platform that provides easy shipment of orders across multiple retailers, online e-commerce platforms or otherwise, and allows shipper to properly bill the recipient for shipment may be provided. Each user (defined as “unique identity that is registered with the platform”) may choose a unique identifier (ID) for identification. Each unique ID may be associated with plurality of PINs, wherein each PIN may represent a physical address. The unique ID may be encrypted.

The platform may integrate with retailers, online e-commerce platforms or otherwise, allowing the user to enter a single unique ID associated with the user's account on the platform. The platform may integrate with multiple couriers, such as FedEx, UPS and DHL and non-standard delivery services. E-commerce platforms, like Amazon, may then prompt the user to enter the unique identifier (ID) which has been associated with a PIN which may be associated with an address the user may want to receive the package at. The use of unique IDs which are associated with PINs by the recipient via the platform prevents user from ever having to re-enter the address information, even across different online e-commerce platforms (amazon, Etsy, eBay, etc.). For each order placed on any platform, the platform may allow the user to select a courier based on multiple parameters, such as, for example, preference, price and delivery time.

Having used the unique ID and PINs across multiple retailers for order fulfillment/shipment, the platform may now provide a real-time tracking of a plurality of orders across multiple retailers and couriers. The user may be able to use the platform to one click reroute or return of packages.

When a package arrives at destination, a plurality of smart devices may be used to verify the shipment. Each smart device represents a pinpoint location where the courier should leave a package and provides proof of package delivery. Each smart device may transmit a signal over a Wi-Fi or Cellular network to a cloud-based service providing an update to the user. One such device may be a sensor that mounts inside a mailbox that notifies the user through the platform when new mail is received. Another example is a door mat that may have an integrated scale. The courier may place the delivered package on the mat, which may verify the weight and notify the user. Yet another example of such smart device is a camera which may identify package characteristics and activity and notify user. Each smart device may be integrated with the platform and associated with a PIN. Another example of a smart device that is not owned by the user, is the courier's smartphone camera which may be integrated via the tracking number to update delivery details.

For shipments that require a digital signature, the user may use their own personal device, such as smart phone, to digitally sign for the package using an app that integrates with the platform. This may be done even when user is away from home. In such circumstance, package may be placed on a smart device, such as the aforementioned mat, for a predetermined amount of time by the shipper, such as 5 minutes. The user may receive an instant notification and a prompt to sign for the package on their device, such as, for example, a computer or smart phone. Upon the user signing for the package, or the predetermined time expiring, whichever comes first, the courier may leave. If the user does not sign within predetermined time, the courier may take the package with them. Alternatively, the user may pre-sign for the package via the platform so that the moment the package is identified as received by the aforementioned mat, the pending signature may automatically get pushed to the courier to satisfy this signature requirement. The user may also simultaneously be notified of the package receipt.

One click return process may utilize either a smart device with integrated scale or manually entered dim-weight data and use of the received package shipment data to streamline the steps required for courier pickup dispatch, shipping charge management and integrated confirmation of package receipt by the original shipper (e.g., e-commerce store). The user may select the received shipment from the platform, the platform may receive the dim-weight data, the user may accept the return charges and method, the user may select if they wish to dispatch the courier for pick up and the process is complete. The user and original shipper may be notified of all updates via the platform.

Embodiments of the present disclosure may comprise methods, systems, and a computer readable medium comprising, but not limited to, at least one of the following:

A. A Designation Receiving Module 108;

B. A Shipping User Identifying Module 110;

C. An Identifier Retrieval Module 112;

D. An Address Location Determination Module 114;

E. A Drop-Off Address Location Determination Module 116;

F. A Courier Designation Module 118;

G. A Courier Providing Module 120;

H. A Shipment Managing Module 122;

I. A Shipment Tracking Module 124;

J. A Device Associating Module 126;

K. An Application Providing Module 128;

L. A Parcel Determination Module 130;

M. A Receive User Notification Module 132;

N. A Receive User Prompting Module 134;

O. A Signature Receiving Module 136;

P. A Status Update Module 138;

Q. A User Registration Receiving Module 140;

R. A Tracking Number Receiving Module 142;

S. A Parcel Tracking Module 144;

T. An Update Message Transmittal Module 146;

U. A Return Initiation Module 148;

V. A Receive User Providing Module 150;

W. A Time Limit Establishing Module 152; and

X. Other Instruction Modules.

Details with regards to each module is provided below. Although modules are disclosed with specific functionality, it should be understood that functionality may be shared between modules, with some functions split between modules, while other functions duplicated by the modules. Furthermore, the name of the module should not be construed as limiting upon the functionality of the module. Moreover, each stage disclosed within each module may be considered independently without the context of the other stages within the same module or different modules. Each stage may contain language defined in other portions of this specifications. Each stage disclosed for one module may be mixed with the operational stages of another module. In the present disclosure, each stage may be claimed on its own and/or interchangeably with other stages of other modules.

The following depicts an example of a method of a plurality of methods that may be performed by at least one of the aforementioned modules. Various hardware components may be used at the various stages of operations disclosed with reference to each module. For example, although methods may be described to be performed by a single computing device, it should be understood that, in some embodiments, different operations may be performed by different networked elements in operative communication with the computing device. For example, a server and/or computing device 300 may be employed in the performance of some or all of the stages disclosed with regard to the methods. Similarly, computing platform 102 may be employed in the performance of some or all of the stages of the methods. As such, computing platform 102 may comprise at least those architectural components as found in computing device 300.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed without altering or deterring from the fundamental scope of the depicted methods and systems disclosed herein.

Consistent with embodiments of the present disclosure, a method may be performed by at least one of the aforementioned modules. The method may be embodied as, for example, but not limited to, computer instructions, which when executed, perform the method. The method may comprise the following stages:

a method for providing a marketplace that enables a plurality of users to ship and receive parcels based on delivery instructions to couriers for the delivery of the parcels; the method comprising:
receiving a designation of at least one parcel to be shipped;
identifying a shipping user of the plurality of users associated with the at least one parcel to be shipped,
   the shipping user being sub-defined as at least one of the following:
      a retailer comprising of at least one of the following: an online retailer and a brick and mortar store, and
      a desiring user that wishes to ship the at least one parcel;

retrieving a unique identifier associated with the shipping user,
the unique identifier associated with the shipping user corresponding to a plurality of pins;

determining a pick-up address and location for the at least one parcel based on a shipping pin of the plurality of pins associated with the shipping user;

defining a receiving user of the plurality of users designated to receive the at least one parcel,
the receiving user being sub-defined as at least one of the following:
   a consumer, and
   the desiring user that wishes to ship at least one parcel;

retrieving a unique identifier associated with the receiving user,
the unique identifier associated with the receiving user corresponding to a plurality of pins;

determining a drop-off address and location for the at least one parcel based on a receiving pin of the plurality of pins associated with the receiving user;

designating a courier for a delivery of the at least one parcel,
wherein designating the courier comprises selecting from a plurality of couriers for delivery of parcels;

providing the courier with instructions comprising:
data associated with the at least one parcel,
the shipping pin associated with the shipping user, the pin defining a pick-up point within the pick-up address and location, and
the receiving pin associated with the receiving user, the pin defining a drop-off point within the drop-off address and location; and
managing a shipment of the at least one parcel;
wherein managing the shipment of the at least one parcel comprises:
   establishing the pick-up point based on the shipping pin associated with the shipping user;
   establishing the drop-off point based on the receiving pin associated with the receiving user;
   enabling a change of the shipping pin selection associated with the shipping user and updating the pick-up point based on the change of the pin associated with the shipping user;
   enabling a change of the receiving pin selection associated with the receiving user and updating the drop-off point based on the change of the pin associated with the receiving user; and
   updating the courier with updated instructions corresponding to the shipment.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

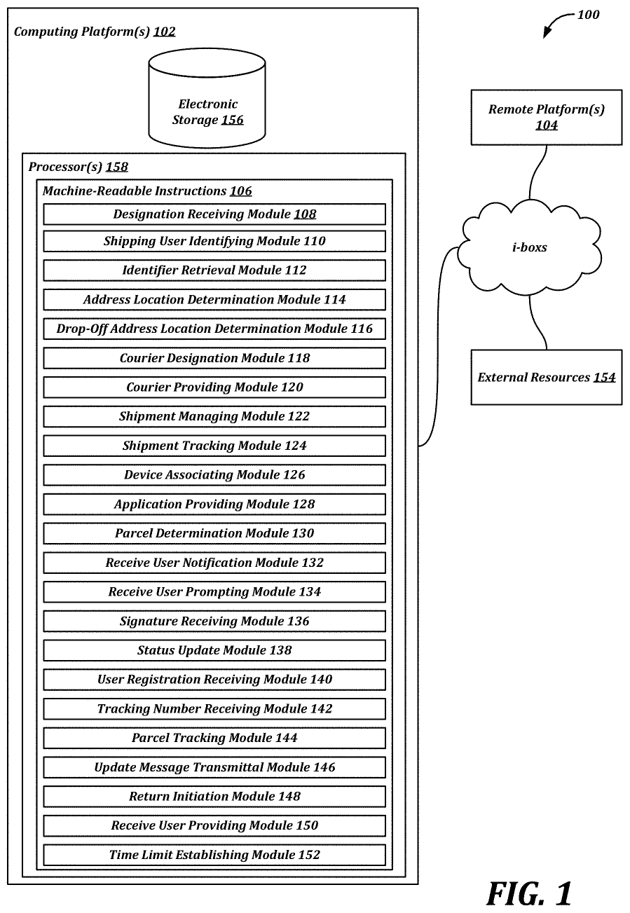

FIG. 1 illustrates one possible operating environment through which a platform consistent with embodiments of the present disclosure may be provided. By way of non-limiting example, an i-boxs computing platform 102 may be hosted on, for example, a cloud computing service. A user may access computing platform 102 through a software application. The software application may be embodied as, for example, but not be limited to, a website, a web application, a desktop application, and a mobile application compatible with a computing device 300. One possible embodiment of the software application may be provided by the i-boxs suite of products and services provided by Luvin Ariza.

### III. Platform Operation

Embodiments of the present disclosure provide a hardware and software platform operative by a set of methods and computer-readable media comprising instructions configured to operate the aforementioned modules and computing elements in accordance with the methods. The following depicts an example of a method of a plurality of methods that may be performed by at least one of the aforementioned modules. Various hardware components may be used at the various stages of operations disclosed with reference to each module.

For example, although methods may be described to be performed by a single computing device, it should be understood that, in some embodiments, different operations may be performed by different networked elements in operative communication with the computing device. For example, a server and/or computing device 300 may be employed in the performance of some or all of the stages disclosed with regard to the methods. Similarly, platform 102 may be employed in the performance of some or all of the stages of the methods. As such, platform 102 may comprise at least those architectural components as found in computing device 300.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

Although the stages are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

FIG. 1 illustrates a system 100 configured for managing a shipment, in accordance with one or more implementations. In some implementations, system 100 may include one or more computing platforms 102. Computing platform(s) 102 may be configured to communicate with one or more remote platforms 104 according to a client/server architecture, a peer-to-peer architecture, and/or other architectures. Remote platform(s) 104 may be configured to communicate with other remote platforms via computing platform(s) 102 and/or according to a client/server architecture, a peer-to-peer architecture, and/or other architectures. Users may access system 100 via remote platform(s) 104.

Computing platform(s) 102 may be configured by machine-readable instructions 106. Machine-readable instructions 106 may include one or more instruction modules. The instruction modules may include computer program modules. The instruction modules may include one or more of designation receiving module 108, shipping user identifying module 110, identifier retrieval module 112, address location determination module 114, drop-off address location determination module 116, courier designation module 118, courier providing module 120, shipment managing module 122, shipment tracking module 124, device associating module 126, application providing module 128, parcel determination module 130, receive user notification module 132, receive user prompting module 134, signature receiving module 136, status update module 138, user registration receiving module 140, tracking number receiving module 142, parcel tracking module 144, update message transmittal module 146, return initiation module 148, receive user providing module 150, time limit establishing module 152, and/or other instruction modules.

Designation receiving module 108 may be configured to receive a designation of at least one parcel to be shipped. Receiving the designation of at least one parcel to be shipped may include receiving date/time of shipment of the at least one parcel and a weight of the at least one parcel. Tracking the at least one parcel may further include receiving a current location of the at least one parcel in real-time. Tracking the at least one parcel may further include receiving a first update when the at least one parcel is shipped. Tracking the at least one parcel may further include receiving a second update when the at least one parcel is delivered.

Tracking the at least one parcel may further include receiving an updated date/time of delivery of the at least one parcel in real-time. Receiving the designation of the at least one parcel to be shipped may include receiving a selection of the at least one pin from the plurality of users instead of receiving at least one of the following pick-up address and location or the destination address and location.

Shipping user identifying module 110 may be configured to identify a shipping user of the plurality of users associated with the at least one parcel to be shipped. Receiving the designation of at least one parcel to be shipped may include providing the shipping user with information required to ship the at least one parcel. The shipping user may be sub-defined as at least one of the following a retailer including of at least one of the following an online retailer and a brick and mortar store and a desiring user that wishes to ship the at least one parcel.

Identifier retrieval module 112 may be configured to retrieve a unique identifier associated with the shipping user. The unique identifier may be associated with the shipping user corresponding to a plurality of pins.

Identifier retrieval module 112 may be configured to retrieve a unique identifier associated with the receiving user. The unique identifier may be associated with the receiving user corresponding to a plurality of pins.

Address location determination module 114 may be configured to determine a pick-up address and location for the at least one parcel based on a shipping pin of the plurality of pins associated with the shipping user.

Drop-off address location determination module 116 may be configured to determine a drop-off address and location for the at least one parcel based on a receiving pin of the plurality of pins associated with the receiving user.

Courier designation module 118 may be configured to designate a courier for a delivery of the at least one parcel. Designating the courier may include selecting from a plurality of couriers for delivery of parcels.

Courier providing module 120 may be configured to provide the courier with instructions.

Shipment managing module 122 may be configured to manage a shipment of the at least one parcel. Managing the shipment of the at least one parcel may include establishing the pick-up point based on the shipping pin associated with the shipping user. Managing the shipment of the at least one parcel may include enabling a change of the shipping pin selection associated with the shipping user and updating the pick-up point based on the change of the pin associated with the shipping user. Managing the shipment of the at least one parcel may include updating the courier with updated instructions corresponding to the shipment. Tracking the shipment of the at least one parcel may further include receiving an input of the unique identifier.

Tracking the shipment of the at least one parcel may further include displaying the status of each parcel being shipped to each pin associated with the unique identifier. Tracking the shipment may further include providing real-time tracking of the at least one parcel to the plurality of users associated with the following the receiving pin and the shipping pin.

Shipment tracking module 124 may be configured to track the shipment of the at least one parcel utilizing a plurality of devices. The plurality of devices may include at least one of the following a sensor mounted inside a mailbox. By way of non-limiting example, the sensor may be configured for detecting the at least one parcel by electro-magnetic sensing and transmitting an update message upon a detection, a doormat with an integrated scale. By way of non-limiting example, the doormat may be configured for detecting the at least one parcel by weight placed on top, the doormat being configured for verifying a weight of the at least one parcel, and the doormat being configured for transmitting the update message upon a verification, and a camera and computing device coupled thereto. By way of non-limiting example, the camera and computing device may be configured for capturing an image of the at least one parcel, the camera and computing device being configured for verifying an aspect of the at least one parcel through the image.

The camera and computing device may be configured for transmitting the update message upon a verification. The verification may indicate that the at least one device located at the drop-off point for the at least one parcel.

Device associating module 126 may be configured to associate each of the plurality of devices with a unique receiving pin associated with the unique identifier corresponding to the receiving user. By way of non-limiting example, the pin may identify an address associated with each of the plurality of devices, to be used as a delivery address, and the pin identifying a location associated with each of the plurality devices to be used as a delivery location. The drop-off point may be included of the address and the location. The pick-up point may be included of the address and the location.

Application providing module 128 may be configured to provide an application on the receiving user device associated with the receiving user. By way of non-limiting example, the application may include at least one of the following a mobile application, a web application, a website, a desktop application, a cloud service, and another application.

Parcel determination module 130 may be configured to determine that the at least one parcel is at the drop-off point by the message from at least one of the plurality of devices.

Receive user notification module 132 may be configured to notify the receiving user when the designed couriers and the at least one parcel is at the drop-off point.

Receive user prompting module 134 may be configured to prompt the receiving user for the digital signature.

Signature receiving module 136 may be configured to receive a digital signature from the receiving user.

Status update module 138 may be configured to update the status of the shipment of the at least one parcel upon receipt of the digital signature.

User registration receiving module 140 may be configured to receive user registration. Receiving the user registration may include receiving personal identifiable information associated with the registering user. Receiving the user registration may include providing the registering user with the unique identifier for identification. Receiving the user registration may include receiving a password for authentication from the registering user. Receiving the user registration may include receiving at least one destination address from the registering user.

Receiving the user registration may include providing the at least one pin for the at least one destination address. Receiving the user registration may include associating the at least one device with the registering user. Receiving the user registration may include receiving payment information from the registering user. The receiving user registration may include registering at least one of the shipping user and the receiving user.

Tracking number receiving module 142 may be configured to receive a tracking number from the designated courier for the at least one parcel.

Parcel tracking module 144 may be configured to track the at least one parcel using the tracking number.

Update message transmittal module 146 may be configured to transmit an update message when the at least one parcel is shipped. Transmitting the update message may include updating a database with a status of the at least one parcel. Transmitting the update message may include providing shipment verification to a receiving user device.

Update message transmittal module 146 may be configured to transmit the update message when the at least one parcel is delivered.

Update message transmittal module 146 may be configured to transmit the update message when a date of delivery changes.

Update message transmittal module 146 may be configured to transmit the update message when a digital signature is required for completing the delivery of the at least one parcel.

Update message transmittal module 146 may be configured to transmit the update message when a current location of the at least one parcel changes.

Update message transmittal module 146 may be configured to transmit the update message of a weight of the parcel.

Return initiation module 148 may be configured to initiate, by the receiving user, a return of the at least one parcel.

Receive user providing module 150 may be configured to provide a receiving user with return instructions for the return of the at least one parcel. Managing the shipment of the at least one parcel may include establishing the drop-off point based on the receiving pin associated with the receiving user. Managing the shipment of the at least one parcel may include enabling a change of the receiving pin selection associated with the receiving user and updating the drop-off point based on the change of the pin associated with the receiving user. Receiving the designation of at least one parcel to be shipped may include identifying the receiving user with the unique identifier. Receiving the designation of at least one parcel to be shipped may include authenticating the receiving user with the password.

Receiving the designation of at least one parcel to be shipped may include receiving a selection of the receiving pin from the plurality of pins associated with the receiving user. Receiving the designation of at least one parcel to be shipped may include providing the receiving user with a choice from the plurality of couriers along with the corresponding rates and speeds for each courier. By way of non-limiting example, receiving the designation of at least one parcel to be shipped may include receiving a selection of the courier, a corresponding courier rate, and a courier speed from the receiving user. Receiving the designation of at least one parcel to be shipped may include billing the receiving user for the shipment. Providing the return instructions may include instructing the user to place the at least one parcel on the at least one device of the plurality devices. Instructing the receiving user may include, if the receiving user configured the doormat with the receiving user device, instructing the user to place the parcel on the doormat.

Instructing the receiving user may include, if the receiving user did not configure the doormat with the receiving user device, instructing the receiving user to drop the parcel off at a nearest drop-off location. Instructing the receiving user may include, if the receiving user did not configure the doormat with the receiving user device, notifying the courier to pick up the at least one parcel and deliver it back to the originating shipping user. Instructing the receiving user may include, if the receiving user did not configure the doormat with the receiving user device, processing the return with the originating shipping user.

Time limit establishing module 152 may be configured to establish a time limit for the receiving user to provide the digital signature. Establishing the time limit may further include providing the courier with instructions to return the at least one parcel to the shipping user if the digital signature is not provided by the user within the time limit.

In some implementations, updating the database may include updating the database in relation to the pin associated with the corresponding device used to transmit the update. In some implementations, by way of non-limiting example, receiving personal identifiable information may include at least one of receiving a first name, receiving a last name, receiving a company name, receiving an e-mail address, receiving a phone number, receiving a primary billing address, receiving a primary mailing address, and receiving other personally identifiable information. In some implementations, selecting from the plurality of couriers may include receiving shipping options from each courier from the plurality of couriers. In some implementations, receiving the shipping options may further include receiving available speeds of shipment. In some implementations, receiving the shipping options may further include receiving date of delivery for the available speeds of shipment.

In some implementations, receiving the shipping options may further include receiving rates for the available speeds of shipment.

In some implementations, computing platform(s) 102, remote platform(s) 104, and/or external resources 154 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 102, remote platform(s) 104, and/or external resources 154 may be operatively linked via some other communication media.

A given remote platform 104 may include one or more processors configured to execute computer program modules. The computer program modules may be configured to enable an expert or user associated with the given remote platform 104 to interface with system 100 and/or external resources 154, and/or provide other functionality attributed herein to remote platform(s) 104. By way of non-limiting example, a given remote platform 104 and/or a given computing platform 102 may include one or more of a server, a desktop computer, a laptop computer, a handheld computer, a tablet computing platform, a NetBook, a Smartphone, a gaming console, and/or other computing platforms.

External resources 154 may include sources of information outside of system 100, external entities participating with system 100, and/or other resources. In some implementations, some or all of the functionality attributed herein to external resources 154 may be provided by resources included in system 100.

Computing platform(s) 102 may include electronic storage 156, one or more processors 158, and/or other components. Computing platform(s) 102 may include communication lines, or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 156 may comprise non-transitory storage media that electronically stores information. The electronic storage media of electronic storage 156 may include one or both of system storage that is provided integrally (i.e., substantially non-removable) with computing platform(s) 102 and/or removable storage that is removably connectable to computing platform(s) 102 via, for example, a port (e.g., a USB port, a firewire port, etc.) or a drive (e.g., a disk drive, etc.). Electronic storage 156 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 156 may include one or more virtual storage resources (e.g., cloud storage, a virtual private network, and/or other virtual storage resources). Electronic storage 156 may store software algorithms, information determined by processor(s) 158, information received from computing platform(s) 102, information received from remote platform(s) 104, and/or other information that enables computing platform(s) 102 to function as described herein.

Processor(s) 158 may be configured to provide information processing capabilities in computing platform(s) 102. As such, processor(s) 158 may include one or more of a digital processor, an analog processor, a digital circuit designed to process information, an analog circuit designed to process information, a state machine, and/or other mechanisms for electronically processing information. Although processor(s) 158 is shown in FIG. 1 as a single entity, this is for illustrative purposes only. In some implementations, processor(s) 158 may include a plurality of processing units. These processing units may be physically located within the same device, or processor(s) 158 may represent processing functionality of a plurality of devices operating in coordination. Processor(s) 158 may be configured to execute modules 108, 110, 112, 114, 116, 118, 120, 122, 124, 126, 128, 130, 132, 134, 136, 138, 140, 142, 144, 146, 148, 150, and/or 152, and/or other modules. Processor(s) 158 may be configured to execute modules 108, 110, 112, 114, 116, 118, 120, 122, 124, 126, 128, 130, 132, 134, 136, 138, 140, 142, 144, 146, 148, 150, and/or 152, and/or other modules by software; hardware; firmware; some combination of software, hardware, and/or firmware; and/or other mechanisms for configuring processing capabilities on processor(s) 158. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, 118, 120, 122, 124, 126, 128, 130, 132, 134, 136, 138, 140, 142, 144, 146, 148, 150, and/or 152 are illustrated in FIG. 1 as being implemented within a single processing unit, in implementations in which processor(s) 158 includes multiple processing units, one or more of modules 108, 110, 112, 114, 116, 118, 120, 122, 124, 126, 128, 130, 132, 134, 136, 138, 140, 142, 144, 146, 148, 150, and/or 152 may be implemented remotely from the other modules. The description of the functionality provided by the different modules 108, 110, 112, 114, 116, 118, 120, 122, 124, 126, 128, 130, 132, 134, 136, 138, 140, 142, 144, 146, 148, 150, and/or 152 described below is for illustrative purposes, and is not intended to be limiting, as any of modules 108, 110, 112, 114, 116, 118, 120, 122, 124, 126, 128, 130, 132, 134, 136, 138, 140, 142, 144, 146, 148, 150, and/or 152 may provide more or less functionality than is described. For example, one or more of modules 108, 110, 112, 114, 116, 118, 120, 122, 124, 126, 128, 130, 132, 134, 136, 138, 140, 142, 144, 146, 148, 150, and/or 152 may be eliminated, and some or all of its functionality may be provided by other ones of modules 108, 110, 112, 114, 116, 118, 120, 122, 124, 126, 128, 130, 132, 134, 136, 138, 140, 142, 144, 146, 148, 150, and/or 152. As another example, processor(s) 158 may be configured to execute one or more additional modules that may perform some or all of the functionality attributed below to one of modules 108, 110, 112, 114, 116, 118, 120, 122, 124, 126, 128, 130, 132, 134, 136, 138, 140, 142, 144, 146, 148, 150, and/or 152.

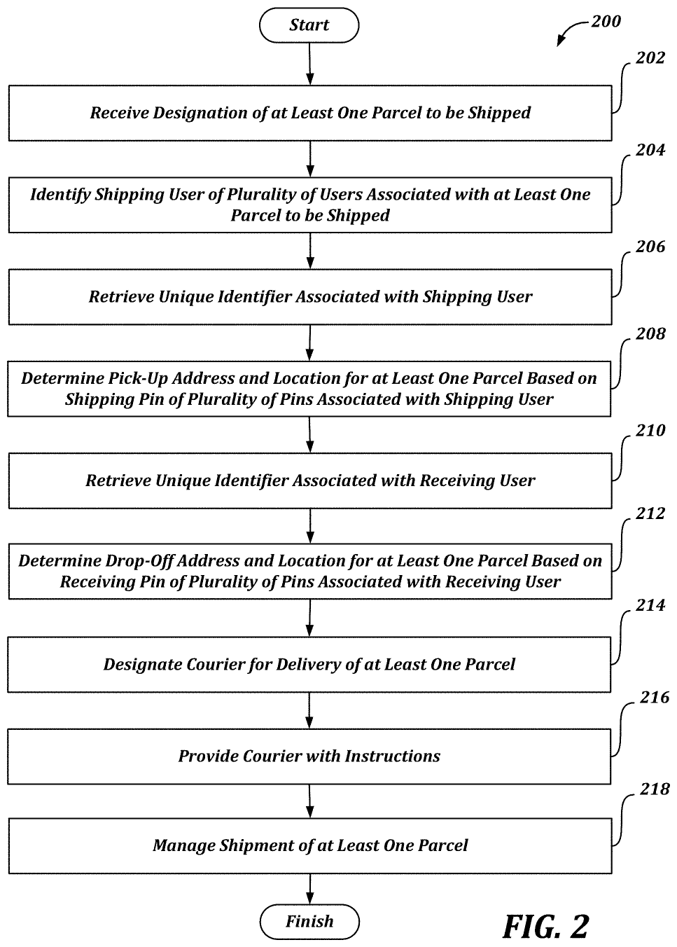

FIG. 2 illustrates a method 200 for managing a shipment, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include receiving a designation of at least one parcel to be shipped. Operation 202 may be performed by one or more hardware processors configured by machine-readable instructions including a module that is the same as or similar to designation receiving module 108, in accordance with one or more implementations.

An operation 204 may include identifying a shipping user of the plurality of users associated with the at least one parcel to be shipped. The shipping user may be sub-defined as at least one of the following a retailer including of at least one of the following an online retailer and a brick and mortar store and a desiring user that wishes to ship the at least one parcel. Operation 204 may be performed by one or more hardware processors configured by machine-readable instructions including a module that is the same as or similar to shipping user identifying module 110, in accordance with one or more implementations.

An operation 206 may include retrieving a unique identifier associated with the shipping user. The unique identifier may be associated with the shipping user corresponding to a plurality of pins. Operation 206 may be performed by one or more hardware processors configured by machine-readable instructions including a module that is the same as or similar to identifier retrieval module 112, in accordance with one or more implementations.

An operation 208 may include determining a pick-up address and location for the at least one parcel based on a shipping pin of the plurality of pins associated with the shipping user. Operation 208 may be performed by one or more hardware processors configured by machine-readable instructions including a module that is the same as or similar to address location determination module 114, in accordance with one or more implementations.

An operation 210 may include retrieving a unique identifier associated with the receiving user. The unique identifier may be associated with the receiving user corresponding to a plurality of pins. Operation 210 may be performed by one or more hardware processors configured by machine-readable instructions including a module that is the same as or similar to identifier retrieval module 112, in accordance with one or more implementations.

An operation 212 may include determining a drop-off address and location for the at least one parcel based on a receiving pin of the plurality of pins associated with the receiving user. Operation 212 may be performed by one or more hardware processors configured by machine-readable instructions including a module that is the same as or similar to drop-off address location determination module 116, in accordance with one or more implementations.

An operation 214 may include designating a courier for a delivery of the at least one parcel. Designating the courier may include selecting from a plurality of couriers for delivery of parcels. Operation 214 may be performed by one or more hardware processors configured by machine-readable instructions including a module that is the same as or similar to courier designation module 118, in accordance with one or more implementations.

An operation 216 may include providing the courier with instructions. Operation 216 may be performed by one or more hardware processors configured by machine-readable instructions including a module that is the same as or similar to courier providing module 120, in accordance with one or more implementations.

An operation 218 may include managing a shipment of the at least one parcel. Operation 218 may be performed by one or more hardware processors configured by machine-readable instructions including a module that is the same as or similar to shipment managing module 122, in accordance with one or more implementations.

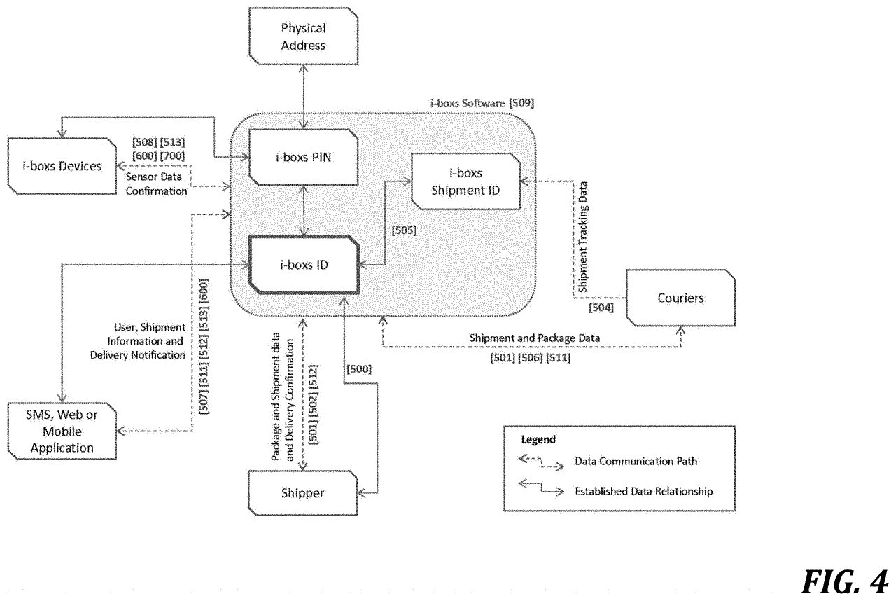

FIG. 4 illustrates a system configured for managing shipments, in accordance with one or more implementations.

In some embodiments, i-boxs software may be provided. In further embodiments, i-boxs software may comprise: an i-boxs PIN, an i-boxs ID, and an i-boxs Shipment ID.

In some embodiments, the i-boxs PIN may comprise at least one physical address.

In some embodiments, a sensor data confirmation may be sent or received to or from an i-boxs device and/or the i-boxs software. In further embodiments, the sensor data confirmation may comprise: a device sensor activation 508, a return package process 600, a received package monitoring 513, and a package dim-weight collection 700.

In some embodiments, a SMS, website or mobile APP may receive or send information, to or from the i-boxs software, wherein the information may comprise: a distribute shipment updates 507, signature required process 511; delivery status update 512; received package monitoring 513, and a return package process 600.

In some embodiments, the couriers may receive or send shipment tracking data to the i-boxs shipment ID. In further embodiments, the shipment tracking data may comprise retrieve tracking numbers 504.

In some embodiments, the couriers may send and receive shipment and package data to or from the i-boxs software. In further embodiments, the shipment and package data may comprise: a courier rate integration 501, a collect shipment updates 506, and a signature required process 511.

In some embodiments, the shipper may send and receive package and shipment data and delivery confirmation from the i-boxs software, wherein package and shipment data and delivery confirmation may comprise: a courier rate integration 501, a courier rate push to shipper 502, and a delivery status update 512.

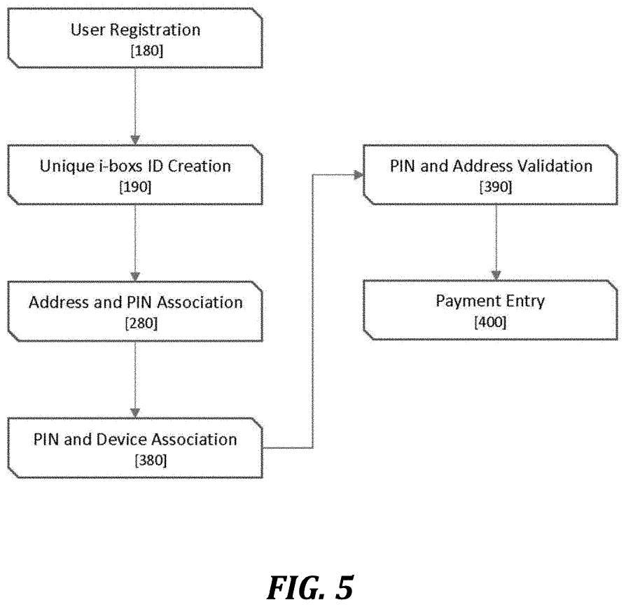

FIG. 5 illustrates a method for user creation, in accordance with one or more implementations. The method for user creation may comprise, but not be limited to, the following steps:

1. User Registration 180;

2. Unique i-boxs ID Creation 190;

3. Address and PIN Association 280;

4. PIN and Device Association 380;

5. PIN and Address Validation 390; and

6. Payment Entry 400.

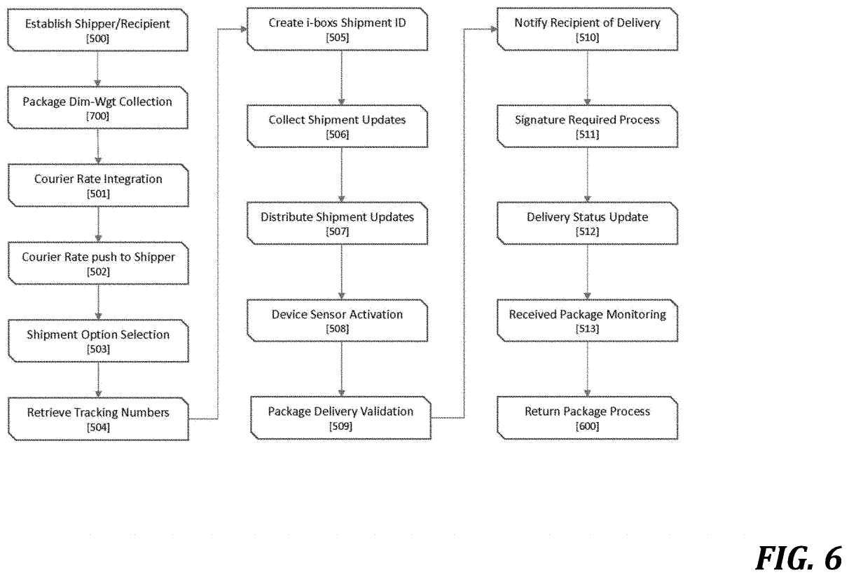

FIG. 6 illustrates a method for managing shipments, in accordance with one or more implementations. The method for managing shipments may comprise, but not be limited to, the following steps:

1. Establish Shipper/Recipient 500;

2. Package Dim-Wgt Collection 700;

3. Courier Rate Integration 501;

4. Courier Rate push to Shipper 502;

5. Shipment Option Selection 503;

6. Retrieve Tracking Numbers 504;

7. Create i-boxs Shipment ID 505;

8. Collect Shipment Updates 506;

9. Distribute Shipment Updates 507;

10. Device Sensor Activation 508;

11. Package Delivery Validation 509;

12. Notify Recipient of Delivery 510;

13. Signature Required Process 511;

14. Delivery Status Update 512;

15. Received Package Monitoring 513; and

16. Return Package Process 600.

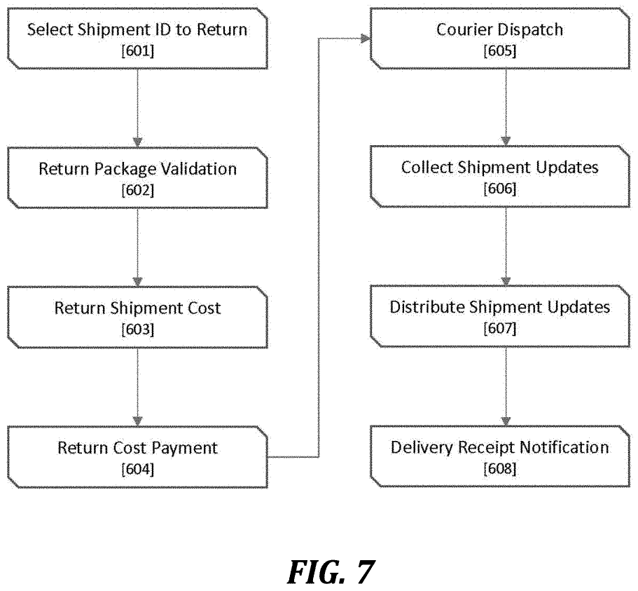

FIG. 7 illustrates a method for returning shipments, in accordance with one or more implementations. The method for returning shipments may comprise, but not be limited to, the following steps:

1. Select Shipment ID to Return 601;

2. Return Package Validation 602;

3. Return Shipment Cost 603;

4. Return Cost Payment 604;

5. Courier Dispatch 605;

6. Collect Shipment Updates 606;

7. Distribute Shipment Updates 607; and

8. Delivery Receipt Notification 608.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation may be combined with one or more features of any other implementation.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 200 will be described in greater detail below.

### IV. Computing Device Architecture

Computing platform (102) may be embodied as, for example, but not be limited to, a website, a web application, a desktop application, backend application, and a mobile application compatible with a computing device (300). The computing device (300) may comprise, but not be limited to the following:
Mobile computing device such as, but is not limited to, a laptop, a tablet, a smartphone, a drone, a wearable, an embedded device, a handheld device, an Arduino, an industrial device, or a remotely operable recording device;
A supercomputer, an exa-scale supercomputer, a mainframe, or a quantum computer;
A minicomputer, wherein the minicomputer computing device comprises, but is not limited to, an IBM AS400/iSeries/System I, A DEC VAX/PDP, a HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack mounted, a workstation, an industrial device, a raspberry pi, a desktop, or an embedded device;
Computing platform (102) may be hosted on a centralized server or a cloud computing service. Although method (200) has been described to be performed by a computing device (300), it should be understood that, in some embodiments, different operations may be performed by a plurality of the computing devices (300) in operative communication over one or more networks.

Embodiments of the present disclosure may comprise a system having a central processing unit (CPU) (320), a bus (330), a memory unit (340), a power supply unit (PSU) (350), and one or more Input/Output (I/O) units. The CPU (320) coupled to the memory unit (340) and the plurality of I/O units (360) via the bus (330), all of which are powered by the PSU (350). It should be understood that, in some embodiments, each disclosed unit may actually be a plurality of such units for the purposes of redundancy, high availability, and/or performance. The combination of the presently disclosed units is configured to perform the stages of method (200).

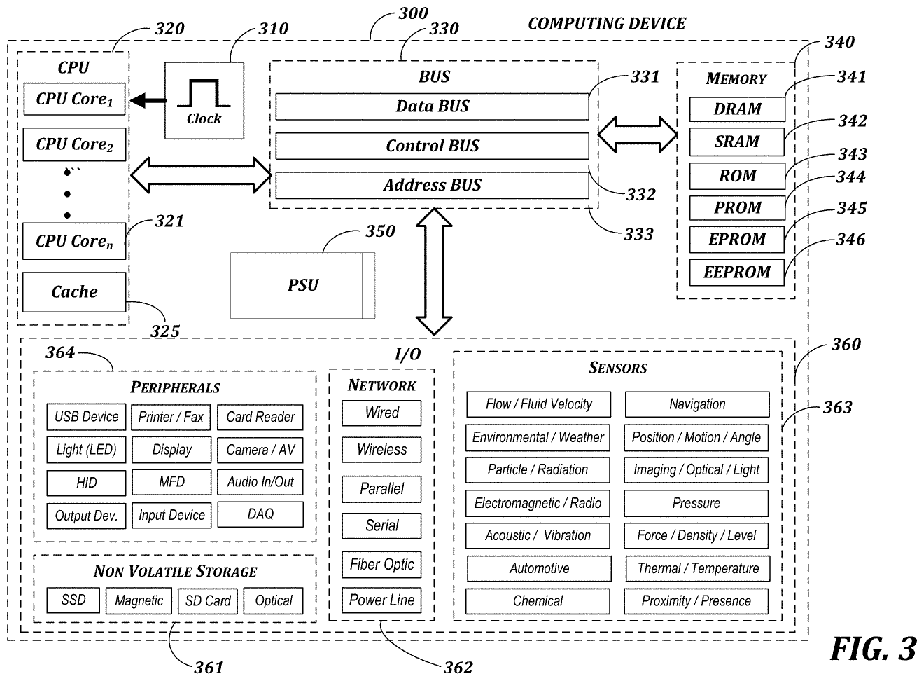

FIG. 3 is a block diagram of a system including computing device (300). Consistent with an embodiment of the disclosure, the aforementioned CPU (320), the bus (330), the memory unit (340), a PSU (350), and the plurality of I/O units (360) may be implemented in a computing device, such as computing device 300 of FIG. 3. Any suitable combination of hardware, software, or firmware may be used to implement the aforementioned units. For example, the CPU (320), the bus (330), and the memory unit (340) may be implemented with computing device 300 or any of other computing devices 318, in combination with computing device 300. The aforementioned system, device, and components are examples and other systems, devices, and components may comprise the aforementioned CPU (320), the bus (330), the memory unit (340), consistent with embodiments of the disclosure.

The computing device (300) may be embodied as any of the computing elements illustrated in FIG. 1A, including, but not limited to, Content Generation Module 125, Content Organization Module 145, Content Display Module 155; and Content Transmission/Streaming Module 135. A computing device (300) does not need to be electronic, nor even have a CPU (320), nor bus (330), nor memory unit (340). The definition of the computing device (300) to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device (300), especially if the processing is purposeful.

With reference to FIG. 3, a system consistent with an embodiment of the disclosure may include a computing device, such as computing device 300. In a basic configuration, computing device 300 may include at least one clock module (310), at least one CPU (320), at least one bus (330), and at least one memory unit (340), at least one PSU (350), and at least one I/O (360) module, wherein I/O module may be comprised of, but not limited to a non-volatile storage sub-module (361), a communication sub-module (362), a sensors sub-module (363), and a peripherals sub-module (364).

A system consistent with an embodiment of the disclosure the computing device 300 may include the clock module (310) may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU (320), the central component of modern computers, which relies on a clock. The only exceptions are asynchronous circuits such as asynchronous CPUs. The clock (310) may comprise a plurality of embodiments, such as, but not limited to:
Single-phase clock which transmits all clock signals on effectively 1 wire
Two-phase clock which distributes clock signals on two wires, each with non-overlapping pulses
Four-phase clock which distributes clock signals on 4 wires

Many computing devices (300) use a “clock multiplier” which multiplies a lower frequency external clock to the appropriate clock rate of the CPU (320). This allows the CPU (320) to operate at a much higher frequency than the rest of the computer, which affords performance gains in situations where the CPU (320) does not need to wait on an external factor (like memory [340] or input/output [360]). Some embodiments of the clock (310) may include dynamic frequency change, where the time between clock edges may vary widely from one edge to the next and back again.

A system consistent with an embodiment of the disclosure the computing device 300 may include the CPU unit (320) comprising at least one CPU Core (321). A plurality of CPU cores (321) may comprise identical the CPU cores (321), such as, but not limited to, homogeneous multi-core systems. It is also possible for the plurality of CPU cores (321) to comprise different the CPU cores (321), such as, but not limited to, heterogeneous multi-core systems, big. LITTLE systems and some AMD accelerated processing units (APU). The CPU unit (321) reads and executes program instructions which may be used across many application domains, for example, but not limited to, general purpose computing, embedded computing, network computing, digital signal processing (DSP), and graphics processing (GPU). The CPU unit (321) may run multiple instructions on separate cores at the same time. The CPU unit (321) may be integrated into at least one of a single integrated circuit die and multiple dies in a single chip package. The single integrated circuit die and multiple dies in a single chip package may contain a plurality of other aspects of the computing device (300), for example, but not limited to, the clock (310), the CPU (320), the bus (330), the memory (340), and I/O (360).

The CPU unit (321) may contain at least one of, but not limited to, a level 1 cache, level 2 cache, level 3 cache (322). The aforementioned cache (322) may or may not be shared amongst a plurality of CPU cores (321). The cache (322) sharing comprises at least one of message passing and inter-core communication methods may be used for the at least one CPU Core (321) to communicate with the cache (322). The inter-core communication methods may comprise, but not limited to, bus, ring, two-dimensional mesh, and crossbar. The aforementioned CPU unit may employ symmetric multiprocessing (SMP) design.

The plurality of the aforementioned CPU cores (321) may comprise soft microprocessor cores on a single field programmable gate array (FPGA), such as semiconductor intellectual property cores (IP Core). The plurality of CPU cores (321) architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores (321), for example, but not limited to Instruction-level parallelism (ILP) such as, but not limited to, superscalar pipelining, and Thread-level parallelism (TLP).

Consistent with the embodiments of the present disclosure, the aforementioned computing device (300) may employ a communication system that transfers data between components inside the aforementioned computing device (300), and/or the plurality of computing devices (300). The aforementioned communication system will be known to a person having ordinary skill in the art as a bus (330). The bus (330) may embody internal and/or external plurality of hardware and software components, for example, but not limited to a wire, optical fiber, communication protocols, and any physical arrangement that provides the same logical function as a parallel electrical bus. The bus (330) may comprise at least one of, but not limited to a parallel bus, wherein the parallel bus carry data words in parallel on multiple wires, and a serial bus, wherein the serial bus carry data in bit-serial form. The bus (330) may embody a plurality of topologies, for example, but not limited to, a multidrop/electrical parallel topology, a daisy chain topology, and a connected by switched hubs, such as USB bus. The bus (330) may comprise a plurality embodiment, for example, but not limited to:
Internal data bus (data bus) (331)/Memory bus
Control bus (332)
Address bus (333)
System Management Bus (SMBus)
Front-Side-Bus (FSB)
External Bus Interface (EBI)
Local bus
Expansion bus
Lightning bus
Controller Area Network (MAY bus)
Camera Link
ExpressCard
Advanced Technology management Attachment (ATA), including embodiments and derivatives such as, but not limited to:
   Integrated Drive Electronics (IDE)
   Enhanced IDE (EIDE)
   ATA Packet Interface (ATAPI)
   Ultra-Direct Memory Access (UDMA)
   Ultra ATA (UATA)
   Parallel ATA (PATA)
   Serial ATA (SATA)
   CompactFlash (CF) interface
   Consumer Electronics ATA (CE-ATA)
   Fiber Attached Technology Adapted (FATA)
   Advanced Host Controller Interface (AHCI)
   SATA Express (SATAe)
   External SATA (eSATA), including the powered embodiment eSATAp
   Mini-SATA (mSATA)
   Next Generation Form Factor (NGFF)/M.2
Small Computer System Interface (SCSI)
Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to:
   Accelerated Graphics Port (AGP)
   Peripheral Component Interconnect eXtended (PCI-X)
   Peripheral Component Interconnect Express (PCI-e) including embodiments such as, but not limited to:
      PCI Express Mini Card including embodiments such as, but not limited to:
      PCI Express M.2 (Mini PCIe v2)
      PCI Express External Cabling (ePCIe)
      PCI Express OCuLink (Optical Copper[Cu] Link)
   Express Card
   AdvancedTCA
   AMC
   Universal IO
   Thunderbolt, including Mini DisplayPort
   Mobile PCIe (M-PCIe)
   U.2
   Non-Volatile Memory Express (NVMe)/Non-Volatile Memory Host Controller Interface Specification (NVMHCIS)
Industry Standard Architecture (ISA) including embodiments such as, but not limited to:
   Extended ISA (EISA)
   PC/XT-bus
   PC/AT-bus
   PC/104 bus, including embodiments such as, but not limited to PC/104-Plus, PCI/104-Express, PCI/104, and PCI-104
   Low Pin Count (LPC)
Music Instrument Digital Interface (MIDI)
Universal Serial Bus (USB) including embodiments such as, but not limited to:
   Media Transfer Protocol (MTP)
   Device Firmware Upgrade (DFU)
   Wireless USB
   InterChip USB
   IEEE 1394 Interface/Firewire
   Thunderbolt
   eXtensible Host Controller Interface (xHCI)
   Mobile High-Definition Link (MHL)

Consistent with the embodiments of the present disclosure, the aforementioned computing device (300) may employ hardware integrated circuits that store information for immediate use in the computing device (300), know to the person having ordinary skill in the art as primary storage or memory (340). The memory (340) operates at high speed, distinguishing it from the non-volatile storage sub-module (361), which may be referred to as secondary or tertiary storage, which provides slow-to-access information but offers higher capacities at lower cost. The contents contained in memory (340), may be transferred to secondary storage via techniques such as, but not limited to, virtual memory and swap. The memory (340) may be associated with addressable semiconductor memory, such as integrated circuits consisting of silicon-based transistors, used for example as primary storage but also other purposes in the computing device (300). The memory (340) may comprise a plurality of embodiments, such as, but not limited to volatile memory, non-volatile memory, and semi-volatile memory. Volatile memory which requires power to maintain stored information, for example, but not limited to:
Dynamic Random-Access Memory (DRAM) (341)
Static Random-Access Memory (SRAM) (342)
CPU Cache memory (325)
Advanced Random-Access Memory (A-RAM)
Other types of primary storage such as Random-Access Memory (RAM)

Non-volatile memory which may retain stored information even after power is removed, for example, but not limited to:
Read-Only Memory (ROM) (343)
Programmable ROM (PROM) (344)
Erasable PROM (EPROM) (345)
Electrically Erasable PROM (EEPROM) (346), including embodiments such as, but not limited to flash memory and Electrically Alterable PROM (EAPROM)
Mask ROM (MROM)
One Time Programmable (OTP) ROM/Write Once Read Many (WORM)
Ferroelectric RAM (FeRAM)
Parallel Random-Access Machine (PRAM)
Split-Transfer Torque RAM (STT-RAM)
Silicon Oxime Nitride Oxide Silicon (SONOS)
Resistive RAM (RRAM)
Nano RAM (NRAM)
3D XPoint
Domain-Wall Memory (DWM)
Millipede memory

Semi-volatile memory which may have some limited non-volatile duration after power is removed but loses data after said duration has passed. Semi-volatile memory provides high performance, durability, and other valuable characteristics typically associated with volatile memory by a person having ordinary skill in the art, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device (300) may employ the communication system between an information processing system, such as the computing device (300), and the outside world, for example, but not limited to, human, environment, and another computing device (300). The aforementioned communication system will be known to a person having ordinary skill in the art as I/O (360). The I/O module (360) regulates a plurality of inputs and outputs with regard to the computing device (300), wherein the inputs are a plurality of signals and data received by the computing device (300), and the outputs are the plurality of signals and data sent from the computing device (300). The I/O module (360) interfaces a plurality of hardware, such as, but not limited to, non-volatile storage (361), communication devices (362), sensors (363), and peripherals (364). The plurality of hardware is used by the at least one of, but not limited to, human, environment, and another computing device (300) to communicate with the present computing device (300). The I/O module (360) may comprise a plurality of forms, for example, but not limited to channel I/O, port-mapped I/O, asynchronous I/O, and Direct Memory Access (DMA).

Consistent with the embodiments of the present disclosure, the aforementioned computing device (300) may employ the non-volatile storage sub-module (361), which may be referred to by a person having ordinary skill in the art as one of secondary storage, external memory, tertiary storage, off-line storage, and auxiliary storage. The non-volatile storage sub-module (361) may not be accessed directly by the CPU (320) without using intermediate area in the memory (340). The non-volatile storage sub-module (361) does not lose data when power is removed and may be two orders of magnitude less costly than storage used in memory module, at the expense of speed and latency. The non-volatile storage sub-module (361) may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (361) may comprise a plurality of embodiments, such as, but not limited to:
Optical storage devices, for example, but not limited to
   Compact Disk (CD) (CD-ROM/CD-R/CD-RW)
   Digital Versatile Disk (DVD) (DVD-ROM/DVD−R/DVD+R/DVD−RW/DVD+RW/DVD±RW/DVD+R DL/DVD-RAM/HD-DVD)
   Blu-ray Disk (BD) (BD-ROM/BD-R/BD-RE/BD-R DL/BD-RE DL)
   Ultra-Density Optical (UDO)
Semiconductor storage, for example, but not limited to:
   Flash memory, such as, but not limited to
      USB flash drive
      Memory card
      Subscriber Identity Module (SIM) card
      Secure Digital (SD) card
      Smart Card
      CompactFlash (CF) card
      Solid State Drive (SSD)
   Memristor
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD)
Molecular Memory
Deoxyribonucleic Acid (DNA) digital data storage

Consistent with the embodiments of the present disclosure, the aforementioned computing device (300) may employ the communication sub-module (362) as a subset of the I/O (360), which may be referred to by a person having ordinary skill in the art as at least one of, but not limited to, computer network, data network, and network. The network allows computing devices (300) to exchange data using connections, which may be known to a person having ordinary skill in the art as data links, between network nodes. The nodes comprise network computer devices (300) that originate, route, and terminate data. The nodes are identified by network addresses and may include a plurality of hosts consistent with the embodiments of a computing device (300). The aforementioned embodiments include, but not limited to personal computers, phones, servers, drones, and networking devices such as, but not limited to, hubs, switches, routers, modems, and firewalls.

Two nodes may be said are networked together, when one computing device (300) is able to exchange information with the other computing device (300), whether or not they have a direct connection with each other. The communication sub-module (362) supports a plurality of applications and services, such as, but not limited to World Wide Web (WWW), digital video and audio, shared use of application and storage computing devices (300), printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to:
IEEE 802
Ethernet
Wireless LAN, known to a person having ordinary skill in the art as WLAN/Wi-Fi
Internet Protocol Suite such as, but not limited to, TCP/IP, UDP, Internet Protocol Version 4 (IPv4), and Internet Protocol Version 6 (IPv6).
Synchronous Optical Networking (SONET) and Synchronous Digital Hierarchy (SDH)
Asynchronous Transfer Mode (ATM)
Cellular standards such as, but not limited to, Global System for Mobile Communications (GSM), General Packet Radio Service (GPRS), Code-Division Multiple Access (CDMA), and Integrated Digital Enhanced Network (IDEN)

The communication sub-module (362) may comprise a plurality of size, topology, traffic control mechanism and organizational intent. The communication sub-module (362) may comprise a plurality of embodiments, such as, but not limited to:
Wired such as, but not limited to, coaxial cable, phone lines, twisted pair cables (ethernet), and InfiniBand.
Wireless communications such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,4G (such as WiMax and LTE), and 5G
Parallel communications such as, but not limited to, LPT ports.
Serial communications such as, but not limited to, RS-232 and USB
Fiber Optic communications such as, but not limited to, Single-mode optical fiber (SMF) and Multi-mode optical fiber (MMF)
Power Line communications

The aforementioned network may comprise a plurality of layouts, such as, but not limited to, bus network such as ethernet, star network such as Wi-Fi, ring network, mesh network, fully connected network, and tree network. The network may be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device (300) may employ the sensors sub-module (363) as a subset of the I/O (360). The sensors sub-module (363) comprises at least one of the devices, modules, and subsystems whose purpose is to detect events or changes in its environment and send the information to the computing device (300). Sensors are sensitive to the measured property, are not sensitive to any property not measured, but may be encountered in its application, and do not significantly influence the measured property. The sensors sub-module (363) may comprise a plurality of digital devices and analog devices, wherein if an analog device is used, an Analog to Digital (A-to-D) converter must be employed to interface the said device with the computing device (300). The sensors may be subject to a plurality of deviations that limit sensor accuracy. The sensors sub-module (363) may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors:
   Breathalyzer
   Carbon dioxide sensor
   Carbon monoxide detector
   Catalytic bead sensor
   Chemical field-effect transistor
   Chemiresistor
   Electrochemical gas sensor
   Electronic nose
   Electrolyte-insulator-semiconductor sensor
   Energy-dispersive X-ray spectroscopy
   Fluorescent chloride sensors
   Holographic sensor
   Hydrocarbon dew point analyzer
   Hydrogen sensor
   Hydrogen sulfide sensor
   Infrared point sensor
   Ion-selective electrode
   Nondispersive infrared sensor
   Microwave chemistry sensor
   Nitrogen oxide sensor
   Olfactometer
   Optode
   Oxygen sensor
   Ozone monitor
   Pellistor
   pH glass electrode
   Potentiometric sensor
   Redox electrode
   Smoke detector
   Zinc oxide nanorod sensor
   Biosensors, such as nanosensors
Automotive Sensors:
   Alarm sensor
   Doppler radar
   Motion detector
   Occupancy sensor
   Proximity sensor
   Passive infrared sensor
   Reed switch
   Stud finder
   Triangulation sensor
   Touch switch
   Wired glove
Acoustic, sound and vibration sensors:
   Microphone
   Lace Sensor (Guitar pickup)
   Seismometer
   Sound locator
   Geophone
   Hydrophone
Electric current, electric potential, magnetic, and radio sensors:
   Current sensor
   Daly detector
   Electroscope
   Electron multiplier
   Faraday cup
   Galvanometer
   Hall effect sensor
   Hall probe
   Magnetic anomaly detector
   Magnetometer
   Magnetoresistance
   MEMS magnetic field sensor
   Metal detector
   Planar Hall sensor
   Radio direction finder
   Voltage detector
Environmental, weather, moisture, and humidity sensors:
   Actinometer
   Air pollution sensor
   Bedwetting alarm
   Ceilometer
   Dew warning
   Electrochemical gas sensor
   Fish counter
   Frequency domain sensor
   Gas detector
   Hook gauge evaporimeter
   Humistor
   Hygrometer
   Leaf sensor
   Lysimeter
   Pyranometer
   Pyrgeometer
   Psychrometer
   Rain gauge
   Rain sensor
   Seismometers
   SNOTEL
   Snow gauge
   Soil moisture sensor
   Stream gauge
   Tide gauge
Flow and fluid velocity sensors:
   Air flow meter
   Anemometer
   Flow sensor
   Gas meter
   Mass flow sensor
   Water meter
Ionizing radiation and particle sensors:
   Cloud chamber
   Geiger counter
   Geiger-Muller tube
   Ionisation chamber
   Neutron detection
   Proportional counter
   Scintillation counter
   Semiconductor detector
   Thermoluminescent dosimeter
Navigation sensors:
   Air speed indicator
   Altimeter
   Attitude indicator
   Depth gauge
   Fluxgate compass
   Gyroscope
   Inertial navigation system
   Inertial reference unit
   Magnetic compass
   MHD sensor
   Ring laser gyroscope
   Turn coordinator
   Variometer
   Vibrating structure gyroscope
   Yaw rate sensor
Position, angle, displacement, distance, speed, and acceleration sensors:
   Accelerometer
   Displacement sensor
   Flex sensor
   Free fall sensor
   Gravimeter
   Impact sensor
   Laser rangefinder
   LIDAR
   Odometer
   Photoelectric sensor
   Position sensor such as GPS or Glonass
   Angular rate sensor
   Shock detector
   Ultrasonic sensor
   Tilt Sensor
   Tachometer
   Ultra-wideband radar
   Variable reluctance sensor
   Velocity receiver
Imaging, optical and light sensors:
   CMOS sensor
   Colorimeter
   Contact Image sensor
   Electro-optical sensor
   Infra-red sensor
   Kinetic inductance detector
   LED as light sensor
   Light-addressable potentiometric sensor
   Nichols radiometer
   Fiber optic sensors
   Optical position sensor
   Thermopile laser sensors
   Photodetector
   Photodiode
   Photomultiplier tubes
   Phototransistor
   Photoelectric sensor
   Photoionization detector
   Photomultiplier
   Photoresistor
   Photoswitch
   Phototube
   Scintillometer
   Shack-Hartmann
   Single-photon avalanche diode
   Superconducting nanowire single-photon detector
   Transition edge sensor
   Visible light photon counter
   Wavefront sensor
Pressure sensors:
   Barograph
   Barometer
   Boost gauge
   Bourdon gauge
   Hot filament ionization gauge
   Ionization gauge
   McLeod gauge
   Oscillating U-tube
   Permanent downhole gauge
   Piezometer
   Pirani gauge
   Pressure sensor
   Pressure gauge
   Tactile sensor
   Time pressure gauge
Force, Density, and Level sensors:
   Barograph
   Barometer
   Boost gauge
   Bourdon gauge
   Hot filament ionization gauge
   Ionization gauge
   McLeod gauge
   Oscillating U-tube
   Permanent downhole gauge
   Piezometer
   Pirani gauge
   Pressure sensor
   Pressure gauge
   Tactile sensor
   Time pressure gauge
Thermal and temperature sensors:
   Bolometer
   Bimetallic strip
   calorimeter
   Exhaust gas temperature gauge
   Flame detection
   Gardon gauge
   Golay cell
   Heat flux sensor
   Infrared thermometer
   Microbolometer
   Microwave radiometer
   Net radiometer
   Quartz thermometer
   Resistance thermometer
   Silicon bandgap temperature sensor
   Special sensor microwave/imager
   Temperature gauge
   Thermistor
   Thermocouple
   Thermometer
   Pyrometer
Proximity and presence sensors:
   Alarm sensor
   Doppler radar
   Motion detector
   Occupancy sensor
   Proximity sensor
   Passive infrared sensor
   Reed switch
   Stud finder
   Triangulation sensor
   Touch switch
   Wired glove

Consistent with the embodiments of the present disclosure, the aforementioned computing device (300) may employ the peripherals sub-module (362) as a subset of the I/O (360). The peripheral sub-module (364) comprises ancillary devices uses to put information into and get information out of the computing device (300). There are 3 categories of devices comprising the peripheral sub-module (364), which exist based on their relationship with the computing device (300), input devices, output devices, and input/output devices. Input devices send at least one of data and instructions to the computing device (300). Input devices may be categorized based on, but not limited to:
Modality of input such as, but not limited to, mechanical motion, audio, and visual
Whether the input is discrete, such as but not limited to, pressing a key, or continuous such as, but not limited to position of a mouse
The number of degrees of freedom involved such as, but not limited to, two-dimensional mice vs three-dimensional mice used for Computer-Aided Design (CAD) applications

Output devices provide output from the computing device (300). Output devices convert electronically generated information into a form that may be presented to humans. Input/output devices perform that perform both input and output functions. It should be understood by a person having ordinary skill in the art that the ensuing are non-limiting embodiments of the aforementioned peripheral sub-module (364):
Input Devices
   Human Interface Devices (HID), such as, but not limited to
      Pointing devices such as, but not limited to, a mouse, touchpad, joystick, touchscreen, game controller/gamepad, remote, light pen, light gun, Wii remote, jog dial, shuttle, and knob.
      Keyboard
      Graphics Tablet
      Digital pen
      Gesture recognition devices
      Magnetic ink character recognition
      Sip-and-Puff (SNP) devices
      Language Acquisition Device (LAD)
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device (300). The information may be stored in a multitude of formats depending on the user's requirement. Examples of types of video input devices include, but not limited to
      Digital camera
      Digital camcorder
      Portable media player
      Webcam
      Microsoft Kinect Sensor
      Image scanner
      Fingerprint scanner
      Barcode reader
      3D scanner
      Laser rangefinder
      Eye gaze tracker
      Computed tomography
      Magnetic resonance imaging
      Positron emission tomography
      Medical ultrasonography
      TV Tuner

Audio input devices are used to capture sound. In some cases, an audio output device may be used as an input device, in order to capture produced sound. Audio input devices allow a user to send audio signals to the computing device (300) for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.

Data AcQuisition (DAQ) devices covert at least one of analog signals and physical parameters to digital values for processing by the computing device (300). Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices, which are most common output devices which convert electrical information into visual form, such as, but not limited to, monitor, TV, projector, and Computer Output Microfilm (COM). Display devices may use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, and Refreshable Braille Display/Braille Terminal.
   Printers such as, but not limited to, inkjet printers, laser printers, 3D printers, and plotters.
   Audio and Video (AV) devices such as, but not limited to, speakers, headphones, and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to:
   Touchscreens
   Networking device, such as a device disclosed in network (362) sub-module
   Data storage device, such as the non-volatile storage (361)
   Facsimile (FAX)
   Graphics Cards
   Sound cards

### V. Aspects

The following disclose various Aspects of the present disclosure. The various Aspects are not to be construed as patent claims unless the language of the Aspect appears as a patent claim. The Aspects describe various non-limiting embodiments of the present disclosure.
Aspect 1. A method for providing a marketplace that enables a plurality of users to ship and receive parcels based on delivery instructions to couriers for the delivery of the parcels; the method comprising:

receiving a designation of at least one parcel to be shipped;

identifying a shipping user of the plurality of users associated with the at least one parcel to be shipped,

the shipping user being sub-defined as at least one of the following:

a retailer comprising of at least one of the following: an online retailer and a brick and mortar store, and

a desiring user that wishes to ship the at least one parcel;

retrieving a unique identifier associated with the shipping user,

the unique identifier associated with the shipping user corresponding to a plurality of pins;

determining a pick-up address and location for the at least one parcel based on a shipping pin of the plurality of pins associated with the shipping user;

defining a receiving user of the plurality of users designated to receive the at least one parcel,

the receiving user being sub-defined as at least one of the following:

a consumer, and

the desiring user that wishes to ship at least one parcel;

retrieving a unique identifier associated with the receiving user,

the unique identifier associated with the receiving user corresponding to a plurality of pins;

determining a drop-off address and location for the at least one parcel based on a receiving pin of the plurality of pins associated with the receiving user;

designating a courier for a delivery of the at least one parcel,

wherein designating the courier comprises selecting from a plurality of couriers for delivery of parcels;

providing the courier with instructions;

comprising:

data associated with the at least one parcel,

the shipping pin associated with the shipping user, the pin defining a pick-up point within the pick-up address and location, and

the receiving pin associated with the receiving user, the pin defining a drop-off point within the drop-off address and location; and

managing a shipment of the at least one parcel;

wherein managing the shipment of the at least one parcel comprises:

establishing the pick-up point based on the shipping pin associated with the shipping user;

wherein managing the shipment of the at least one parcel comprises establishing the drop-off point based on the receiving pin associated with the receiving user;

wherein managing the shipment of the at least one parcel comprises enabling a change of the shipping pin selection associated with the shipping user and updating the pick-up point based on the change of the pin associated with the shipping user;

wherein managing the shipment of the at least one parcel comprises enabling a change of the receiving pin selection associated with the receiving user and updating the drop-off point based on the change of the pin associated with the receiving user; and

wherein managing the shipment of the at least one parcel comprises updating the courier with updated instructions corresponding to the shipment.
Aspect 2. The method of Aspect 1, further comprising:

tracking the shipment of the at least one parcel utilizing a plurality of devices,

the plurality of devices comprising at least one of the following:

a sensor mounted inside a mailbox,

the sensor being configured for:

detecting the at least one parcel by electro-magnetic sensing, and

transmitting an update message upon a detection,

a doormat with an integrated scale,

the doormat being configured for: detecting the at least one parcel by weight placed on top,

the doormat being configured for verifying a weight of the at least one parcel, and

the doormat being configured for transmitting the update message upon a verification, and

a camera and computing device coupled thereto,

the camera and computing device being configured for: capturing an image of the at least one parcel,

the camera and computing device being configured for verifying an aspect of the at least one parcel through the image, and

the camera and computing device being configured for transmitting the update message upon a verification.
Aspect 3. The method of Aspect 2, further comprising:

associating each of the plurality of devices with a unique receiving pin associated with the unique identifier corresponding to the receiving user, the pin identifying:

an address associated with each of the plurality of devices, to be used as a delivery address, and

the pin identifying a location associated with each of the plurality devices, to be used as a delivery location;

wherein the drop-off point is comprised of the address and the location; and

wherein the pick-up point is comprised of the address and the location.
Aspect 4. The method of Aspect 2, wherein transmitting the update message comprises:

updating a database with a status of the at least one parcel;

wherein updating the database comprises updating the database in relation to the pin associated with the corresponding device used to transmit the update.
Aspect 5. The method of Aspect 2, wherein transmitting the update message comprises: providing shipment verification to a receiving user device, the verification indicating that the at least one device located at the drop-off point for the at least one parcel.
Aspect 6. The method of Aspect 2, further comprising:

providing an application on the receiving user device associated with the receiving user,

the application comprising at least one of the following: a mobile application, a web application, a website, a desktop application, a cloud service, and another application;

determining that the at least one parcel is at the drop-off point by the message from at least one of the plurality of devices;

notifying the receiving user when the designed couriers courier's and the at least one parcel is at the drop-off point;

prompting the receiving user for the digital signature;

receiving a digital signature from the receiving user; and

updating the status of the shipment of the at least one parcel upon receipt of the digital signature.
Aspect 7. The method of Aspect 2, wherein tracking the shipment of the at least one parcel further comprises:

receiving an input of the unique identifier; and

wherein tracking the shipment of the at least one parcel further comprises displaying the status of each parcel being shipped to each pin associated with the unique identifier.
Aspect 8. The method of Aspect 2, further comprising:

receiving user registration,

wherein the receiving user registration comprises:

registering at least one of the shipping user and the receiving user.
Aspect 9. The method of Aspect 8, wherein receiving the user registration comprises: receiving personal identifiable information associated with the registering user;

wherein receiving personal identifiable information comprises at least one of:

receiving a first name,

receiving a last name,

receiving a company name,

receiving an e-mail address,

receiving a phone number,

receiving a primary billing address,

receiving a primary mailing address, and

receiving other personally identifiable information.
Aspect 10. The method of Aspect 8, wherein receiving the user registration comprises: providing the registering user with the unique identifier for identification;

wherein receiving the user registration comprises receiving a password for authentication from the registering user;

wherein receiving the user registration comprises receiving at least one destination address from the registering user;

wherein receiving the user registration comprises providing the at least one pin for the at least one destination address;

wherein receiving the user registration comprises associating the at least one device with the registering user; and

wherein receiving the user registration comprises receiving payment information from the registering user.
Aspect 11. The method of Aspect 1, wherein selecting from the plurality of couriers comprises:

receiving shipping options from each courier from the plurality of couriers;

wherein receiving the shipping options further comprises:

receiving available speeds of shipment;

receiving delivery date for the available speeds of shipment; and

receiving rates for the available speeds of shipment.
Aspect 12. The method of Aspect 1, wherein receiving the designation of at least one parcel to be shipped comprises:

identifying the receiving user with the unique identifier;

wherein receiving the designation of at least one parcel to be shipped comprises authenticating the receiving user with the password;

wherein receiving the designation of at least one parcel to be shipped comprises receiving a selection of the receiving pin from the plurality of pins associated with the receiving user;

wherein receiving the designation of at least one parcel to be shipped comprises providing the receiving user with a choice from the plurality of couriers along with the corresponding rates and speeds for each courier;

wherein receiving the designation of at least one parcel to be shipped comprises receiving a selection of the courier, a corresponding courier rate, and a courier speed from the receiving user;

wherein receiving the designation of at least one parcel to be shipped comprises providing the shipping user with information required to ship the at least one parcel;

wherein receiving the designation of at least one parcel to be shipped comprises receiving date/time of shipment of the at least one parcel and a weight of the at least one parcel; and

wherein receiving the designation of at least one parcel to be shipped comprises billing the receiving user for the shipment.
Aspect 13. The method of Aspect 1, further comprising:

receiving a tracking number from the designated courier for the at least one parcel; and

tracking the at least one parcel using the tracking number;

wherein tracking the at least one parcel further comprises receiving a current location of the at least one parcel in real-time;

wherein tracking the at least one parcel further comprises receiving a first update when the at least one parcel is shipped;

wherein tracking the at least one parcel further comprises receiving a second update when the at least one parcel is delivered; and

wherein tracking the at least one parcel further comprises receiving an updated date/time of delivery of the at least one parcel in real-time
Aspect 14. The method of Aspect 1, further comprising:

transmitting an update message when the at least one parcel is shipped;

transmitting the update message when the at least one parcel is delivered;

transmitting the update message when a date of delivery changes;

transmitting the update message when a digital signature is required for completing the delivery of the at least one parcel;

transmitting the update message when a current location of the at least one parcel changes; and

transmitting the update message of a weight of the parcel.
Aspect 15. The method of Aspect 2, further comprising:

initiating, by the receiving user, a return of the at least one parcel;

providing a receiving user with return instructions for the return of the at least one parcel;

wherein providing the return instructions comprises instructing the user to place the at least one parcel on the at least one device of the plurality devices; and

wherein instructing the receiving user comprises, if the receiving user configured the doormat with the receiving user device:

instructing the user to place the parcel on the doormat;

wherein instructing the receiving user comprises, if the receiving user did not configure the doormat with the receiving user device:

instructing the receiving user to drop the parcel off at a nearest drop-off location;

wherein instructing the receiving user comprises, if the receiving user did not configure the doormat with the receiving user device, notifying the courier to pick up the at least one parcel and deliver it back to the originating shipping user; and

wherein instructing the receiving user comprises, if the receiving user did not configure the doormat with the receiving user device, processing the return with the originating shipping user.
Aspect 16. The method of Aspect 6, further comprising:

establishing a time limit for the receiving user to provide the digital signature;

wherein establishing the time limit further comprises providing the courier with instructions to return the at least one parcel to the shipping user if the digital signature is not provided by the user within the time limit.
Aspect 17. The method of Aspect 1, wherein receiving the designation of the at least one parcel to be shipped comprises:

receiving a selection of the at least one pin from the plurality of users, instead of receiving at least one of the following:

pick-up address and location, and/or

the drop-off address and location.
Aspect 18. The method of Aspect 7, wherein tracking the shipment further comprises:

providing real-time tracking of the at least one parcel to the plurality of users associated with the following:

the receiving pin, and

the shipping pin.
Aspect 19. i-boxs MAT (Package Receiving Sensor) is a physical, electronic device designed with a sensor and scale to detect presence and differential weight of a package placed onto it. Once the package is detected, it will transmit a signal over a Wi-Fi or Cellular network to a cloud-based service providing an update indicating when a package is physically delivered to the specific device registered to a residential or commercial address. The information transmitted will include time of delivery, package weight which will then be linked via Big Data to couriers tracking data. i-boxs MAT can be located in any secure location the consumer would prefer to receive or send packages.
Aspect 20. Shipper—Any entity that wish to ship a physical package using i-boxs software (e.g., User, Online Store or Brick and Mortar Store).
Aspect 21. Online Store—Any website utilizing a catalog of physical products with an integrated shopping cart to complete online purchasing and shipping transactions.
Aspect 22. Brick and Mortar Store—Any merchant with a physical location that wishes to ship a physical product to an i-boxs ID.
Aspect 23. i-boxs ID Table—Table that holds unique user specific information. Data fields include: i-boxes ID; First Name; Last Name; email address; Password; Phone Number; Active PIN.
Aspect 24. i-boxs Shipment ID Table—Table that holds unique shipment specific information. Data fields include: i-boxs ID; Shipment ID; i-boxs PIN; Ship From i-boxs ID; Courier; Tracking No; Package DIMS; Package Weight; Shipment Cost; Class of Service; Expected Delivery Date; Device Receipt Confirmation; Received Weight; Received Date; Signature Required; eSignature Received; Return Tracking Number; Return Package Weight; Return Package Payor; Return Package Cost; Return Package Ship Date.
Aspect 25. i-boxs PIN Table—Table that holds unique physical address information. Data fields include: iboxs ID; i-boxs PIN; Street Address; City; St; Zip; Device ID; MAC Address.
Aspect 26.

20. The method of any preceding aspect, further comprising:

tracking the shipment of the at least one parcel utilizing a plurality of devices, the plurality of devices comprising at least one of the following a sensor mounted inside a mailbox, the sensor being configured for detecting the at least one parcel by electro-magnetic sensing and transmitting an update message upon a detection, a doormat with an integrated scale, the doormat being configured for detecting the at least one parcel by weight placed on top, the doormat being configured for verifying a weight of the at least one parcel, and the doormat being configured for transmitting the update message upon a verification, and a camera and computing device coupled thereto, the camera and computing device being configured for capturing an image of the at least one parcel, the camera and computing device being configured for verifying an aspect of the at least one parcel through the image, and the camera and computing device being configured for transmitting the update message upon a verification.

21. The method of any preceding aspect, further comprising:

associating each of the plurality of devices with a unique receiving pin associated with the unique identifier corresponding to the receiving user, the pin identifying an address associated with each of the plurality of devices, to be used as a delivery address, and the pin identifying a location associated with each of the plurality of devices to be used as a delivery location,

wherein the drop-off point is comprised of the address and the location,

wherein the pick-up point is comprised of the address and the location.

22. The method of any preceding aspect, wherein transmitting the update message comprises updating a database with a status of the at least one parcel,

wherein updating the database comprises updating the database in relation to the pin associated with a corresponding device used to transmit the update.

23. The method of any preceding aspect, wherein transmitting the update message comprises providing shipment verification to a receiving user device, the shipment verification indicating that the at least one device located at the drop-off point for the at least one parcel.

24. The method of any preceding aspect, further comprising:

providing an application on the receiving user device associated with the receiving user, the application comprising at least one of the following a mobile application, a web application, a website, a desktop application, a cloud service, and another application;

determining that the at least one parcel is at the drop-off point by the update message from at least one of the plurality of devices;

notifying the receiving user when the designated courier and the at least one parcel is at the drop-off point;

prompting the receiving user for a digital signature;

receiving the digital signature from the receiving user; and

updating the status of the shipment of the at least one parcel upon receipt of the digital signature.

25. The method of any preceding aspect, wherein tracking the shipment of the at least one parcel further comprises receiving an input of the unique identifier,

wherein tracking the shipment of the at least one parcel further comprises displaying the status of each of the at least one parcel being shipped to each pin associated with the unique identifier.

26. The method of any preceding aspect, further comprising:

receiving user registration, wherein receiving the user registration comprises registering at least one of the shipping user and the receiving user.

27. The method of any preceding aspect, wherein receiving the user registration comprises receiving personal identifiable information associated with the registering user,

wherein receiving the personal identifiable information comprises at least one of receiving a first name, receiving a last name, receiving a company name, receiving an e-mail address, receiving a phone number, receiving a primary billing address, receiving a primary mailing address, and receiving other personally identifiable information.

28. The method of any preceding aspect, wherein receiving the user registration comprises providing the registering user with the unique identifier for identification,

wherein receiving the user registration comprises receiving a password for authentication from the registering user,

wherein receiving the user registration comprises receiving at least one destination address from the registering user,

wherein receiving the user registration comprises providing the at least one pin for the at least one destination address,

wherein receiving the user registration comprises associating the at least one device with the registering user,

wherein receiving the user registration comprises receiving payment information from the registering user.

29. The method of any preceding aspect, wherein selecting from the plurality of couriers comprises receiving shipping options from each of the plurality of couriers,

wherein receiving the shipping options further comprises receiving available speeds of shipment,

wherein receiving the shipping options further comprises receiving date of delivery for the available speeds of shipment,

wherein receiving the shipping options further comprises receiving rates for the available speeds of shipment.

30. The method of any preceding aspect, wherein receiving the designation of at least one parcel to be shipped comprises identifying the receiving user with the unique identifier,

wherein receiving the designation of at least one parcel to be shipped comprises authenticating the receiving user with a password,

wherein receiving the designation of at least one parcel to be shipped comprises receiving a selection of the receiving pin from the plurality of pins associated with the receiving user,

wherein receiving the designation of at least one parcel to be shipped comprises providing the receiving user with a choice from the plurality of couriers along with a plurality of corresponding courier rates and a plurality of courier speeds for each of the plurality of couriers,

wherein receiving the designation of at least one parcel to be shipped comprises receiving a selection of the courier, one of the plurality of corresponding courier rates, and one of the plurality of courier speeds from the receiving user,

wherein receiving the designation of at least one parcel to be shipped comprises providing the shipping user with information required to ship the at least one parcel,

wherein receiving the designation of at least one parcel to be shipped comprises receiving date/time of shipment of the at least one parcel and a weight of the at least one parcel,

wherein receiving the designation of at least one parcel to be shipped comprises billing the receiving user for the shipment.

31. The method of any preceding aspect, further comprising:

receiving a tracking number from the designated courier for the at least one parcel; and

tracking the at least one parcel using the tracking number,

wherein tracking the at least one parcel further comprises receiving a current location of the at least one parcel in real-time,

wherein tracking the at least one parcel further comprises receiving a first update when the at least one parcel is shipped,

wherein tracking the at least one parcel further comprises receiving a second update when the at least one parcel is delivered,

wherein tracking the at least one parcel further comprises receiving an updated date/time of delivery of the at least one parcel in real-time.

32. The method of any preceding aspect, further comprising:

transmitting an update message when the at least one parcel is shipped;

transmitting the update message when the at least one parcel is delivered;

transmitting the update message when a date of delivery changes;

transmitting the update message when a digital signature is required for completing the delivery of the at least one parcel;

transmitting the update message when a current location of the at least one parcel changes; and

transmitting the update message of a weight of the at least one parcel.

33. The method of any preceding aspect, further comprising:

initiating, by the receiving user, a return of the at least one parcel; and

providing a receiving user with return instructions for the return of the at least one parcel;

wherein providing the return instructions comprises instructing the user to place the at least one parcel on the at least one device of the plurality of devices,

wherein instructing the receiving user comprises, when the receiving user configured the doormat with the receiving user device, instructing the user to place the at least one parcel on the doormat,

wherein instructing the receiving user comprises, when the receiving user did not configure the doormat with the receiving user device, instructing the receiving user to drop the at least one parcel off at a nearest drop-off location,

wherein instructing the receiving user comprises, when the receiving user did not configure the doormat with the receiving user device, notifying the courier to pick up the at least one parcel and deliver it back to an originating shipping user,

wherein instructing the receiving user comprises, when the receiving user did not configure the doormat with the receiving user device, processing the return with the originating shipping user.

34. The method of any preceding aspect, further comprising:

stablishing a time limit for the receiving user to provide the digital signature; and

wherein establishing the time limit further comprises providing the courier with instructions to return the at least one parcel to the shipping user when the digital signature is not provided by the user within the time limit.

35. The method of any preceding aspect, wherein receiving the designation of the at least one parcel to be shipped comprises receiving a selection of the at least one pin from the plurality of users instead of receiving at least one of the following:
a pick-up address and location, and
a destination address and location.

36. The method of any preceding aspect, wherein tracking the shipment further comprises providing real-time tracking of the at least one parcel to the plurality of users associated with the following the receiving pin and the shipping pin.
Aspect 27.

38. The computer-readable storage medium of any preceding aspect, wherein the method further comprises:

tracking the shipment of the at least one parcel utilizing a plurality of devices, the plurality of devices comprising at least one of the following a sensor mounted inside a mailbox, the sensor being configured for detecting the at least one parcel by electro-magnetic sensing and transmitting an update message upon a detection, a doormat with an integrated scale, the doormat being configured for detecting the at least one parcel by weight placed on top, the doormat being configured for verifying a weight of the at least one parcel, and the doormat being configured for transmitting the update message upon a verification, and a camera and computing device coupled thereto, the camera and computing device being configured for capturing an image of the at least one parcel, the camera and computing device being configured for verifying an aspect of the at least one parcel through the image, and the camera and computing device being configured for transmitting the update message upon a verification.

39. The computer-readable storage medium of any preceding aspect, wherein the method further comprises:

associating each of the plurality of devices with a unique receiving pin associated with the unique identifier corresponding to the receiving user, the pin identifying an address associated with each of the plurality of devices, to be used as a delivery address, and the pin identifying a location associated with each of the plurality of devices to be used as a delivery location,

wherein the drop-off point is comprised of the address and the location,

wherein the pick-up point is comprised of the address and the location.

40. The computer-readable storage medium of any preceding aspect, wherein transmitting the update message comprises updating a database with a status of the at least one parcel,

wherein updating the database comprises updating the database in relation to the pin associated with a corresponding device used to transmit the update.

41. The computer-readable storage medium of any preceding aspect, wherein transmitting the update message comprises providing shipment verification to a receiving user device, the shipment verification indicating that the at least one device located at the drop-off point for the at least one parcel.

42. The computer-readable storage medium of any preceding aspect, wherein the method further comprises:

providing an application on the receiving user device associated with the receiving user, the application comprising at least one of the following a mobile application, a web application, a website, a desktop application, a cloud service, and another application;

determining that the at least one parcel is at the drop-off point by the update message from at least one of the plurality of devices;

notifying the receiving user when the designated courier and the at least one parcel is at the drop-off point;

prompting the receiving user for a digital signature;

receiving the digital signature from the receiving user; and

updating the status of the shipment of the at least one parcel upon receipt of the digital signature.

43. The computer-readable storage medium of any preceding aspect, wherein tracking the shipment of the at least one parcel further comprises receiving an input of the unique identifier,

wherein tracking the shipment of the at least one parcel further comprises displaying the status of each of the at least one parcel being shipped to each pin associated with the unique identifier.

44. The computer-readable storage medium of any preceding aspect, wherein the method further comprises:

receiving user registration, wherein receiving the user registration comprises registering at least one of the shipping user and the receiving user.

45. The computer-readable storage medium of any preceding aspect, wherein receiving the user registration comprises receiving personal identifiable information associated with the registering user,

wherein receiving the personal identifiable information comprises at least one of receiving a first name, receiving a last name, receiving a company name, receiving an e-mail address, receiving a phone number, receiving a primary billing address, receiving a primary mailing address, and receiving other personally identifiable information.

46. The computer-readable storage medium of any preceding aspect, wherein receiving the user registration comprises providing the registering user with the unique identifier for identification,

wherein receiving the user registration comprises receiving a password for authentication from the registering user,

wherein receiving the user registration comprises receiving at least one destination address from the registering user,

wherein receiving the user registration comprises providing the at least one pin for the at least one destination address,

wherein receiving the user registration comprises associating the at least one device with the registering user,

wherein receiving the user registration comprises receiving payment information from the registering user.

47. The computer-readable storage medium of any preceding aspect, wherein selecting from the plurality of couriers comprises receiving shipping options from each of the plurality of couriers,

wherein receiving the shipping options further comprises receiving available speeds of shipment,

wherein receiving the shipping options further comprises receiving date of delivery for the available speeds of shipment,

wherein receiving the shipping options further comprises receiving rates for the available speeds of shipment.

48. The computer-readable storage medium of any preceding aspect, wherein receiving the designation of at least one parcel to be shipped comprises identifying the receiving user with the unique identifier,

wherein receiving the designation of at least one parcel to be shipped comprises authenticating the receiving user with a password,

wherein receiving the designation of at least one parcel to be shipped comprises receiving a selection of the receiving pin from the plurality of pins associated with the receiving user,

wherein receiving the designation of at least one parcel to be shipped comprises providing the receiving user with a choice from the plurality of couriers along with a plurality of corresponding courier rates and a plurality of courier speeds for each of the plurality of couriers,

wherein receiving the designation of at least one parcel to be shipped comprises receiving a selection of the courier, one of the plurality of corresponding courier rates, and one of the plurality of courier speeds from the receiving user,

wherein receiving the designation of at least one parcel to be shipped comprises providing the shipping user with information required to ship the at least one parcel,

wherein receiving the designation of at least one parcel to be shipped comprises receiving date/time of shipment of the at least one parcel and a weight of the at least one parcel,

wherein receiving the designation of at least one parcel to be shipped comprises billing the receiving user for the shipment.

49. The computer-readable storage medium of any preceding aspect, wherein the method further comprises:

receiving a tracking number from the designated courier for the at least one parcel; and

tracking the at least one parcel using the tracking number;

wherein tracking the at least one parcel further comprises receiving a current location of the at least one parcel in real-time,

wherein tracking the at least one parcel further comprises receiving a first update when the at least one parcel is shipped,

wherein tracking the at least one parcel further comprises receiving a second update when the at least one parcel is delivered,

wherein tracking the at least one parcel further comprises receiving an updated date/time of delivery of the at least one parcel in real-time.

50. The computer-readable storage medium of any preceding aspect, wherein the method further comprises:

transmitting an update message when the at least one parcel is shipped;

transmitting the update message when the at least one parcel is delivered;

transmitting the update message when a date of delivery changes;

transmitting the update message when a digital signature is required for completing the delivery of the at least one parcel;

transmitting the update message when a current location of the at least one parcel changes; and

transmitting the update message of a weight of the at least one parcel.

51. The computer-readable storage medium of any preceding aspect, wherein the method further comprises:

initiating, by the receiving user, a return of the at least one parcel; and

providing a receiving user with return instructions for the return of the at least one parcel,

wherein providing the return instructions comprises instructing the user to place the at least one parcel on the at least one device of the plurality of devices,

wherein instructing the receiving user comprises, when the receiving user configured the doormat with the receiving user device, instructing the user to place the at least one parcel on the doormat,

wherein instructing the receiving user comprises, when the receiving user did not configure the doormat with the receiving user device, instructing the receiving user to drop the at least one parcel off ata nearest drop-off location,

wherein instructing the receiving user comprises, when the receiving user did not configure the doormat with the receiving user device, notifying the courier to pick up the at least one parcel and deliver it back to an originating shipping user,

wherein instructing the receiving user comprises, when the receiving user did not configure the doormat with the receiving user device, processing the return with the originating shipping user.

52. The computer-readable storage medium of any preceding aspect, wherein the method further comprises:

establishing a time limit for the receiving user to provide the digital signature,

wherein establishing the time limit further comprises providing the courier with instructions to return the at least one parcel to the shipping user when the digital signature is not provided by the user within the time limit.

53. The computer-readable storage medium of any preceding aspect, wherein receiving the designation of the at least one parcel to be shipped comprises receiving a selection of the at least one pin from the plurality of users instead of receiving at least one of the following:
a pick-up address and location, and
a destination address and location.

54. The computer-readable storage medium of claim 43, wherein tracking the shipment further comprises providing real-time tracking of the at least one parcel to the plurality of users associated with the following the receiving pin and the shipping pin.
Aspect 28

The software may integrate with major courier and e-commerce, to combine big data analytics and reporting via a cloud-based subscription service, providing shipping tracker and integrator tools. The software enables the provision of a more competitive marketplace, which benefits not only e-commerce platforms and couriers, but most of all the user, as it provides more options and lower cost. Further, it offers a unified platform for monitoring and management of all incoming shipments to the user as well as confirmation of delivery.
Aspect 29

The software may be a cloud-based algorithm that reconciles physical addresses with uniquely coded PINs. Each PIN may be attached to a smart device (SMS or MAT) and synchronized to an APP by scanning a QR code to each device. Each user may be assigned a unique ID referred to as a User ID. Each User ID may have multiple delivery PINs or locations where they may receive shipments. Combined with the integration of major couriers and e-commerce platforms, the software may allow for a more pleasant user experience, wherein the user does not need to re-enter shipping information over and over.
Aspect 30

The software may integrate the connection between hardware devices and the platform to broadcast notifications in real-time when the mail or packages have been delivered or picked up.

### VI. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A system configured for managing a shipment, the system comprising:
one or more hardware processors configured by machine-readable instructions to:
receive a designation of at least one parcel to be shipped;
identify a shipping user of the plurality of users associated with the at least one parcel to be shipped, the shipping user being sub-defined as at least one of the following:
a retailer comprising of at least one of the following:
an online retailer, and
a brick and mortar store, and
a desiring user that wishes to ship the at least one parcel;
retrieve a unique identifier associated with the shipping user, the unique identifier associated with the shipping user corresponding to a plurality of pins;
determine a pick-up address and location for the at least one parcel based on a shipping pin of the plurality of pins associated with the shipping user;
retrieve a unique identifier associated with the receiving user, the unique identifier associated with the receiving user corresponding to a plurality of pins;
determine a drop-off address and location for the at least one parcel based on a receiving pin of the plurality of pins associated with the receiving user;
designate a courier for a delivery of the at least one parcel, wherein designating the courier comprises selecting from a plurality of couriers for delivery of parcels;
provide the courier with instructions; and
manage a shipment of the at least one parcel;
wherein managing the shipment of the at least one parcel comprises establishing the pick-up point based on the shipping pin associated with the shipping user;
wherein managing the shipment of the at least one parcel comprises establishing the drop-off point based on the receiving pin associated with the receiving user;
wherein managing the shipment of the at least one parcel comprises enabling a change of the shipping pin selection associated with the shipping user and updating the pick-up point based on the change of the pin associated with the shipping user;
wherein managing the shipment of the at least one parcel comprises enabling a change of the receiving pin selection associated with the receiving user and updating the drop-off point based on the change of the pin associated with the receiving user; and
wherein managing the shipment of the at least one parcel comprises updating the courier with updated instructions corresponding to the shipment.

2. The system of claim 1, wherein the one or more hardware processors are further configured by machine-readable instructions to:
track the shipment of the at least one parcel utilizing a plurality of devices, the plurality of devices comprising at least one of the following a sensor mounted inside a mailbox, the sensor being configured for detecting the at least one parcel by electro-magnetic sensing and transmitting an update message upon a detection, a doormat with an integrated scale, the doormat being configured for detecting the at least one parcel by weight placed on top, the doormat being configured for verifying a weight of the at least one parcel, and the doormat being configured for transmitting the update message upon a verification, and a camera and computing device coupled thereto, the camera and computing device being configured for capturing an image of the at least one parcel, the camera and computing device being configured for verifying an aspect of the at least one parcel through the image, and the camera and computing device being configured for transmitting the update message upon a verification.

3. The system of claim 2, wherein the one or more hardware processors are further configured by machine-readable instructions to:
associate each of the plurality of devices with a unique receiving pin associated with the unique identifier corresponding to the receiving user, the pin identifying an address associated with each of the plurality of devices, to be used as a delivery address, and the pin identifying a location associated with each of the plurality devices to be used as a delivery location;
wherein the drop-off point is comprised of the address and the location; and
wherein the pick-up point is comprised of the address and the location.

4. The system of claim 2, wherein transmitting the update message comprises updating a database with a status of the at least one parcel;
wherein updating the database comprises updating the database in relation to the pin associated with the corresponding device used to transmit the update.

5. The system of claim 2, wherein transmitting the update message comprises providing shipment verification to a receiving user device, the verification indicating that the at least one device located at the drop-off point for the at least one parcel.

6. The system of claim 2, wherein the one or more hardware processors are further configured by machine-readable instructions to:
provide an application on the receiving user device associated with the receiving user, the application comprising at least one of the following a mobile application, a web application, a website, a desktop application, a cloud service, and another application;
determine that the at least one parcel is at the drop-off point by the message from at least one of the plurality of devices;
notify the receiving user when the designed couriers and the at least one parcel is at the drop-off point;
prompt the receiving user for the digital signature;
receive a digital signature from the receiving user;
update the status of the shipment of the at least one parcel upon receipt of the digital signature.

7. The system of claim 2, wherein tracking the shipment of the at least one parcel further comprises receiving an input of the unique identifier; and
wherein tracking the shipment of the at least one parcel further comprises displaying the status of each parcel being shipped to each pin associated with the unique identifier.

8. The system of claim 2, wherein the one or more hardware processors are further configured by machine-readable instructions to:
receive user registration, wherein the receiving user registration comprises registering at least one of the shipping user and the receiving user.

9. The system of claim 8, wherein receiving the user registration comprises receiving personal identifiable information associated with the registering user;
wherein receiving personal identifiable information comprises at least one of receiving a first name, receiving a last name, receiving a company name, receiving an e-mail address, receiving a phone number, receiving a primary billing address, receiving a primary mailing address, and receiving other personally identifiable information.

10. The system of claim 9, wherein receiving the user registration comprises providing the registering user with the unique identifier for identification;
receiving the user registration comprises receiving a password for authentication from the registering user;
receiving the user registration comprises receiving at least one destination address from the registering user;
receiving the user registration comprises providing the at least one pin for the at least one destination address;
receiving the user registration comprises associating the at least one device with the registering user; and
receiving the user registration comprises receiving payment information from the registering user.

11. The system of claim 1, wherein selecting from the plurality of couriers comprises receiving shipping options from each courier from the plurality of couriers;
wherein receiving the shipping options further comprises receiving available speeds of shipment;
wherein receiving the shipping options further comprises receiving date of delivery for the available speeds of shipment; and
wherein receiving the shipping options further comprises receiving rates for the available speeds of shipment.

12. The system of claim 1, wherein receiving the designation of at least one parcel to be shipped comprises identifying the receiving user with the unique identifier;
wherein receiving the designation of at least one parcel to be shipped comprises authenticating the receiving user with the password;
wherein receiving the designation of at least one parcel to be shipped comprises receiving a selection of the receiving pin from the plurality of pins associated with the receiving user;
wherein receiving the designation of at least one parcel to be shipped comprises providing the receiving user with a choice from the plurality of couriers along with the corresponding rates and speeds for each courier;
wherein receiving the designation of at least one parcel to be shipped comprises receiving a selection of the courier, a corresponding courier rate, and a courier speed from the receiving user;
wherein receiving the designation of at least one parcel to be shipped comprises providing the shipping user with information required to ship the at least one parcel;
wherein receiving the designation of at least one parcel to be shipped comprises receiving date/time of shipment of the at least one parcel and a weight of the at least one parcel; and
wherein receiving the designation of at least one parcel to be shipped comprises billing the receiving user for the shipment.

13. The system of claim 1, wherein the one or more hardware processors are further configured by machine-readable instructions to:
receive a tracking number from the designated courier for the at least one parcel;
track the at least one parcel using the tracking number;
wherein tracking the at least one parcel further comprises receiving a current location of the at least one parcel in real-time;
wherein tracking the at least one parcel further comprises receiving a first update when the at least one parcel is shipped;
wherein tracking the at least one parcel further comprises receiving a second update when the at least one parcel is delivered; and
wherein tracking the at least one parcel further comprises receiving an updated date/time of delivery of the at least one parcel in real-time.

14. The system of claim 1, wherein the one or more hardware processors are further configured by machine-readable instructions to:
transmit an update message when the at least one parcel is shipped;
transmit the update message when the at least one parcel is delivered;
transmit the update message when a date of delivery changes;
transmit the update message when a digital signature is required for completing the delivery of the at least one parcel;
transmit the update message when a current location of the at least one parcel changes;
transmit the update message of a weight of the parcel.

15. The system of claim 2, wherein the one or more hardware processors are further configured by machine-readable instructions to:
initiate, by the receiving user, a return of the at least one parcel;
provide a receiving user with return instructions for the return of the at least one parcel;
wherein providing the return instructions comprises instructing the user to place the at least one parcel on the at least one device of the plurality devices; and
wherein instructing the receiving user comprises, when the receiving user configured the doormat with the receiving user device, instructing the user to place the parcel on the doormat;
wherein instructing the receiving user comprises, when the receiving user did not configure the doormat with the receiving user device, instructing the receiving user to drop the parcel off at a nearest drop-off location;
wherein instructing the receiving user comprises, when the receiving user did not configure the doormat with the receiving user device, notifying the courier to pick up the at least one parcel and deliver it back to the originating shipping user; and
wherein instructing the receiving user comprises, when the receiving user did not configure the doormat with the receiving user device, processing the return with the originating shipping user.

16. The system of claim 6, wherein the one or more hardware processors are further configured by machine-readable instructions to:
establish a time limit for the receiving user to provide the digital signature;
wherein establishing the time limit further comprises providing the courier with instructions to return the at least one parcel to the shipping user when the digital signature is not provided by the user within the time limit.

17. The system of claim 1, wherein receiving the designation of the at least one parcel to be shipped comprises receiving a selection of the at least one pin from the plurality of users instead of receiving at least one of the following pick-up address and location or the destination address and location.

18. The system of claim 7, wherein tracking the shipment further comprises providing real-time tracking of the at least one parcel to the plurality of users associated with the following the receiving pin and the shipping pin.

19. A method for managing a shipment, comprising:
receiving a designation of at least one parcel to be shipped;
identifying a shipping user of the plurality of users associated with the at least one parcel to be shipped, the shipping user being sub-defined as at least one of the following a retailer comprising of at least one of the following an online retailer and a brick and mortar store and a desiring user that wishes to ship the at least one parcel;
retrieving a unique identifier associated with the shipping user, the unique identifier associated with the shipping user corresponding to a plurality of pins;
determining a pick-up address and location for the at least one parcel based on a shipping pin of the plurality of pins associated with the shipping user;
retrieving a unique identifier associated with the receiving user, the unique identifier associated with the receiving user corresponding to a plurality of pins;
determining a drop-off address and location for the at least one parcel based on a receiving pin of the plurality of pins associated with the receiving user;
designating a courier for a delivery of the at least one parcel, wherein designating the courier comprises selecting from a plurality of couriers for delivery of parcels;
providing the courier with instructions;
managing a shipment of the at least one parcel;
wherein managing the shipment of the at least one parcel comprises establishing the pick-up point based on the shipping pin associated with the shipping user;
wherein managing the shipment of the at least one parcel comprises establishing the drop-off point based on the receiving pin associated with the receiving user;
wherein managing the shipment of the at least one parcel comprises enabling a change of the shipping pin selection associated with the shipping user and updating the pick-up point based on the change of the pin associated with the shipping user;
wherein managing the shipment of the at least one parcel comprises enabling a change of the receiving pin selection associated with the receiving user and updating the drop-off point based on the change of the pin associated with the receiving user; and
wherein managing the shipment of the at least one parcel comprises updating the courier with updated instructions corresponding to the shipment.

20. The method of claim 19, further comprising:
tracking the shipment of the at least one parcel utilizing a plurality of devices, the plurality of devices comprising at least one of the following a sensor mounted inside a mailbox, the sensor being configured for detecting the at least one parcel by electro-magnetic sensing and transmitting an update message upon a detection, a doormat with an integrated scale, the doormat being configured for detecting the at least one parcel by weight placed on top, the doormat being configured for verifying a weight of the at least one parcel, and the doormat being configured for transmitting the update message upon a verification, and a camera and computing device coupled thereto, the camera and computing device being configured for capturing an image of the at least one parcel, the camera and computing device being configured for verifying an aspect of the at least one parcel through the image, and the camera and computing device being configured for transmitting the update message upon a verification.

21. The method of claim 20, further comprising:
associating each of the plurality of devices with a unique receiving pin associated with the unique identifier corresponding to the receiving user, the pin identifying an address associated with each of the plurality of devices, to be used as a delivery address, and the pin identifying a location associated with each of the plurality devices to be used as a delivery location;
wherein the drop-off point is comprised of the address and the location; and
wherein the pick-up point is comprised of the address and the location.

22. The method of claim 20, wherein transmitting the update message comprises updating a database with a status of the at least one parcel;
wherein updating the database comprises updating the database in relation to the pin associated with the corresponding device used to transmit the update.

23. The method of claim 20, wherein transmitting the update message comprises providing shipment verification to a receiving user device, the verification indicating that the at least one device located at the drop-off point for the at least one parcel.

24. The method of claim 20, further comprising:
providing an application on the receiving user device associated with the receiving user, the application comprising at least one of the following a mobile application, a web application, a website, a desktop application, a cloud service, and another application;
determining that the at least one parcel is at the drop-off point by the message from at least one of the plurality of devices;
notifying the receiving user when the designed couriers and the at least one parcel is at the drop-off point;
prompting the receiving user for the digital signature;
receiving a digital signature from the receiving user; and
updating the status of the shipment of the at least one parcel upon receipt of the digital signature.

25. The method of claim 20, wherein tracking the shipment of the at least one parcel further comprises receiving an input of the unique identifier; and
wherein tracking the shipment of the at least one parcel further comprises displaying the status of each parcel being shipped to each pin associated with the unique identifier.

26. The method of claim 20, further comprising:
receiving user registration, wherein the receiving user registration comprises registering at least one of the shipping user and the receiving user.

27. The method of claim 26, wherein receiving the user registration comprises receiving personal identifiable information associated with the registering user;
wherein receiving personal identifiable information comprises at least one of receiving a first name, receiving a last name, receiving a company name, receiving an e-mail address, receiving a phone number, receiving a primary billing address, receiving a primary mailing address, and receiving other personally identifiable information.

28. The method of claim 27, wherein receiving the user registration comprises providing the registering user with the unique identifier for identification;
wherein receiving the user registration comprises receiving a password for authentication from the registering user;
wherein receiving the user registration comprises receiving at least one destination address from the registering user;
wherein receiving the user registration comprises providing the at least one pin for the at least one destination address;
wherein receiving the user registration comprises associating the at least one device with the registering user; and
wherein receiving the user registration comprises receiving payment information from the registering user.

29. The method of claim 19, wherein selecting from the plurality of couriers comprises receiving shipping options from each courier from the plurality of couriers;
wherein receiving the shipping options further comprises receiving available speeds of shipment;
wherein receiving the shipping options further comprises receiving date of delivery for the available speeds of shipment; and
wherein receiving the shipping options further comprises receiving rates for the available speeds of shipment.

30. The method of claim 19, wherein receiving the designation of at least one parcel to be shipped comprises identifying the receiving user with the unique identifier;
wherein receiving the designation of at least one parcel to be shipped comprises authenticating the receiving user with the password;
wherein receiving the designation of at least one parcel to be shipped comprises receiving a selection of the receiving pin from the plurality of pins associated with the receiving user;
wherein receiving the designation of at least one parcel to be shipped comprises providing the receiving user with a choice from the plurality of couriers along with the corresponding rates and speeds for each courier;
wherein receiving the designation of at least one parcel to be shipped comprises receiving a selection of the courier, a corresponding courier rate, and a courier speed from the receiving user;
wherein receiving the designation of at least one parcel to be shipped comprises providing the shipping user with information required to ship the at least one parcel;
wherein receiving the designation of at least one parcel to be shipped comprises receiving date/time of shipment of the at least one parcel and a weight of the at least one parcel; and
wherein receiving the designation of at least one parcel to be shipped comprises billing the receiving user for the shipment.

31. The method of claim 19, further comprising:
receiving a tracking number from the designated courier for the at least one parcel; and
tracking the at least one parcel using the tracking number;
wherein tracking the at least one parcel further comprises receiving a current location of the at least one parcel in real-time;
wherein tracking the at least one parcel further comprises receiving a first update when the at least one parcel is shipped;
wherein tracking the at least one parcel further comprises receiving a second update when the at least one parcel is delivered; and
wherein tracking the at least one parcel further comprises receiving an updated date/time of delivery of the at least one parcel in real-time.

32. The method of claim 19, further comprising:
transmitting an update message when the at least one parcel is shipped;
transmitting the update message when the at least one parcel is delivered;
transmitting the update message when a date of delivery changes;
transmitting the update message when a digital signature is required for completing the delivery of the at least one parcel;
transmitting the update message when a current location of the at least one parcel changes; and
transmitting the update message of a weight of the parcel.

33. The method of claim 20, further comprising:
initiating, by the receiving user, a return of the at least one parcel;
providing a receiving user with return instructions for the return of the at least one parcel;
wherein providing the return instructions comprises instructing the user to place the at least one parcel on the at least one device of the plurality devices; and
wherein instructing the receiving user comprises, when the receiving user configured the doormat with the receiving user device, instructing the user to place the parcel on the doormat;
wherein instructing the receiving user comprises, when the receiving user did not configure the doormat with the receiving user device, instructing the receiving user to drop the parcel off at a nearest drop-off location;
wherein instructing the receiving user comprises, when the receiving user did not configure the doormat with the receiving user device, notifying the courier to pick up the at least one parcel and deliver it back to the originating shipping user; and
wherein instructing the receiving user comprises, when the receiving user did not configure the doormat with the receiving user device, processing the return with the originating shipping user.

34. The method of claim 24, further comprising:
stablishing a time limit for the receiving user to provide the digital signature; and
wherein establishing the time limit further comprises providing the courier with instructions to return the at least one parcel to the shipping user when the digital signature is not provided by the user within the time limit.

35. The method of claim 19, wherein receiving the designation of the at least one parcel to be shipped comprises receiving a selection of the at least one pin from the plurality of users instead of receiving at least one of the following pick-up address and location or the destination address and location.

36. The method of claim 25, wherein tracking the shipment further comprises providing real-time tracking of the at least one parcel to the plurality of users associated with the following the receiving pin and the shipping pin.

37. A non-transient computer-readable storage medium having instructions embodied thereon, the instructions being executable by one or more processors to perform a method for managing a shipment, the method comprising:
receiving a designation of at least one parcel to be shipped;
identifying a shipping user of the plurality of users associated with the at least one parcel to be shipped, the shipping user being sub-defined as at least one of the following a retailer comprising of at least one of the following an online retailer and a brick and mortar store and a desiring user that wishes to ship the at least one parcel;
retrieving a unique identifier associated with the shipping user, the unique identifier associated with the shipping user corresponding to a plurality of pins;
determining a pick-up address and location for the at least one parcel based on a shipping pin of the plurality of pins associated with the shipping user;
retrieving a unique identifier associated with the receiving user, the unique identifier associated with the receiving user corresponding to a plurality of pins;
determining a drop-off address and location for the at least one parcel based on a receiving pin of the plurality of pins associated with the receiving user;
designating a courier for a delivery of the at least one parcel, wherein designating the courier comprises selecting from a plurality of couriers for delivery of parcels;
providing the courier with instructions;
managing a shipment of the at least one parcel;
wherein managing the shipment of the at least one parcel comprises establishing the pick-up point based on the shipping pin associated with the shipping user;
wherein managing the shipment of the at least one parcel comprises establishing the drop-off point based on the receiving pin associated with the receiving user;
wherein managing the shipment of the at least one parcel comprises enabling a change of the shipping pin selection associated with the shipping user and updating the pick-up point based on the change of the pin associated with the shipping user;
wherein managing the shipment of the at least one parcel comprises enabling a change of the receiving pin selection associated with the receiving user and updating the drop-off point based on the change of the pin associated with the receiving user; and
wherein managing the shipment of the at least one parcel comprises updating the courier with updated instructions corresponding to the shipment.

38. The computer-readable storage medium of claim 37, wherein the method further comprises:
tracking the shipment of the at least one parcel utilizing a plurality of devices, the plurality of devices comprising at least one of the following a sensor mounted inside a mailbox, the sensor being configured for detecting the at least one parcel by electro-magnetic sensing and transmitting an update message upon a detection, a doormat with an integrated scale, the doormat being configured for detecting the at least one parcel by weight placed on top, the doormat being configured for verifying a weight of the at least one parcel, and the doormat being configured for transmitting the update message upon a verification, and a camera and computing device coupled thereto, the camera and computing device being configured for capturing an image of the at least one parcel, the camera and computing device being configured for verifying an aspect of the at least one parcel through the image, and the camera and computing device being configured for transmitting the update message upon a verification.

39. The computer-readable storage medium of claim 38, wherein the method further comprises:
associating each of the plurality of devices with a unique receiving pin associated with the unique identifier corresponding to the receiving user, the pin identifying an address associated with each of the plurality of devices, to be used as a delivery address, and the pin identifying a location associated with each of the plurality devices to be used as a delivery location;
wherein the drop-off point is comprised of the address and the location; and
wherein the pick-up point is comprised of the address and the location.

40. The computer-readable storage medium of claim 38, wherein transmitting the update message comprises updating a database with a status of the at least one parcel;
wherein updating the database comprises updating the database in relation to the pin associated with the corresponding device used to transmit the update.

41. The computer-readable storage medium of claim 38, wherein transmitting the update message comprises providing shipment verification to a receiving user device, the verification indicating that the at least one device located at the drop-off point for the at least one parcel.

42. The computer-readable storage medium of claim 38, wherein the method further comprises:
providing an application on the receiving user device associated with the receiving user, the application comprising at least one of the following a mobile application, a web application, a website, a desktop application, a cloud service, and another application;
determining that the at least one parcel is at the drop-off point by the message from at least one of the plurality of devices;
notifying the receiving user when the designed couriers and the at least one parcel is at the drop-off point;
prompting the receiving user for the digital signature;
receiving a digital signature from the receiving user; and
updating the status of the shipment of the at least one parcel upon receipt of the digital signature.

43. The computer-readable storage medium of claim 38, wherein tracking the shipment of the at least one parcel further comprises receiving an input of the unique identifier; and
wherein tracking the shipment of the at least one parcel further comprises displaying the status of each parcel being shipped to each pin associated with the unique identifier.

44. The computer-readable storage medium of claim 38, wherein the method further comprises:
receiving user registration, wherein the receiving user registration comprises registering at least one of the shipping user and the receiving user.

45. The computer-readable storage medium of claim 44, wherein receiving the user registration comprises receiving personal identifiable information associated with the registering user;
wherein receiving personal identifiable information comprises at least one of receiving a first name, receiving a last name, receiving a company name, receiving an e-mail address, receiving a phone number, receiving a primary billing address, receiving a primary mailing address, and receiving other personally identifiable information.

46. The computer-readable storage medium of claim 45, wherein receiving the user registration comprises providing the registering user with the unique identifier for identification;
wherein receiving the user registration comprises receiving a password for authentication from the registering user;
wherein receiving the user registration comprises receiving at least one destination address from the registering user;
wherein receiving the user registration comprises providing the at least one pin for the at least one destination address;
wherein receiving the user registration comprises associating the at least one device with the registering user; and
wherein receiving the user registration comprises receiving payment information from the registering user.

47. The computer-readable storage medium of claim 37, wherein selecting from the plurality of couriers comprises receiving shipping options from each courier from the plurality of couriers;
wherein receiving the shipping options further comprises receiving available speeds of shipment;
wherein receiving the shipping options further comprises receiving date of delivery for the available speeds of shipment; and
wherein receiving the shipping options further comprises receiving rates for the available speeds of shipment.

48. The computer-readable storage medium of claim 37, wherein receiving the designation of at least one parcel to be shipped comprises identifying the receiving user with the unique identifier;
wherein receiving the designation of at least one parcel to be shipped comprises authenticating the receiving user with the password;
wherein receiving the designation of at least one parcel to be shipped comprises receiving a selection of the receiving pin from the plurality of pins associated with the receiving user;
wherein receiving the designation of at least one parcel to be shipped comprises providing the receiving user with a choice from the plurality of couriers along with the corresponding rates and speeds for each courier;
wherein receiving the designation of at least one parcel to be shipped comprises receiving a selection of the courier, a corresponding courier rate, and a courier speed from the receiving user;
wherein receiving the designation of at least one parcel to be shipped comprises providing the shipping user with information required to ship the at least one parcel;
wherein receiving the designation of at least one parcel to be shipped comprises receiving date/time of shipment of the at least one parcel and a weight of the at least one parcel; and
wherein receiving the designation of at least one parcel to be shipped comprises billing the receiving user for the shipment.

49. The computer-readable storage medium of claim 37, wherein the method further comprises:
receiving a tracking number from the designated courier for the at least one parcel; and
tracking the at least one parcel using the tracking number;
wherein tracking the at least one parcel further comprises receiving a current location of the at least one parcel in real-time;
wherein tracking the at least one parcel further comprises receiving a first update when the at least one parcel is shipped;
wherein tracking the at least one parcel further comprises receiving a second update when the at least one parcel is delivered; and
wherein tracking the at least one parcel further comprises receiving an updated date/time of delivery of the at least one parcel in real-time.

50. The computer-readable storage medium of claim 37, wherein the method further comprises:
transmitting an update message when the at least one parcel is shipped;
transmitting the update message when the at least one parcel is delivered;
transmitting the update message when a date of delivery changes;
transmitting the update message when a digital signature is required for completing the delivery of the at least one parcel;
transmitting the update message when a current location of the at least one parcel changes; and
transmitting the update message of a weight of the parcel.

51. The computer-readable storage medium of claim 38, wherein the method further comprises:
initiating, by the receiving user, a return of the at least one parcel;
providing a receiving user with return instructions for the return of the at least one parcel;
wherein providing the return instructions comprises instructing the user to place the at least one parcel on the at least one device of the plurality devices; and
wherein instructing the receiving user comprises, when the receiving user configured the doormat with the receiving user device, instructing the user to place the parcel on the doormat;
wherein instructing the receiving user comprises, when the receiving user did not configure the doormat with the receiving user device, instructing the receiving user to drop the parcel off at a nearest drop-off location;
wherein instructing the receiving user comprises, when the receiving user did not configure the doormat with the receiving user device, notifying the courier to pick up the at least one parcel and deliver it back to the originating shipping user; and
wherein instructing the receiving user comprises, when the receiving user did not configure the doormat with the receiving user device, processing the return with the originating shipping user.

52. The computer-readable storage medium of claim 42, wherein the method further comprises:
establishing a time limit for the receiving user to provide the digital signature;
wherein establishing the time limit further comprises providing the courier with instructions to return the at least one parcel to the shipping user when the digital signature is not provided by the user within the time limit.

53. The computer-readable storage medium of claim 37, wherein receiving the designation of the at least one parcel to be shipped comprises receiving a selection of the at least one pin from the plurality of users instead of receiving at least one of the following pick-up address and location or the destination address and location.

54. The computer-readable storage medium of claim 43, wherein tracking the shipment further comprises providing real-time tracking of the at least one parcel to the plurality of users associated with the following the receiving pin and the shipping pin.
